(19) United States
(12) Patent Application Publication
(10) Pub. No.: US 2026/0162603 A1
(43) Pub. Date: Jun. 11, 2026

(54) PIXEL CIRCUIT, DRIVING METHOD THEREOF AND DISPLAY DEVICE

(71) Applicants: HEFEI BOE JOINT TECHNOLOGY CO., LTD., Hefei (CN); BOE TECHNOLOGY GROUP CO., LTD., Beijing (CN); BEIJING BOE TECHNOLOGY DEVELOPMENT CO., LTD., Beijing (CN)

(72) Inventors: Xuehuan FENG, Beijing (CN); Yongqian LI, Beijing (CN)

(21) Appl. No.: 18/725,301

(22) PCT Filed: Aug. 31, 2023
(86) PCT No.: PCT/CN2023/116309

§ 371 Date: Jun. 28, 2024

(51) Int. Cl. G09G 3/3233; G09G 3/32

(52) U.S. Cl. CPC G09G 3/3233; G09G 3/32; G09G 2300/043; G09G 2300/0819; G09G 2300/0842; G09G 2310/08; G09G 2320/0233; G09G 2320/045

(57) ABSTRACT

A pixel circuit, a driving method thereof and a display device are provided. The pixel circuit includes a driving circuit and a data writing circuit, the driving circuit being configured to control the magnitude of a driving current flowing through the first terminal and the second terminal; the first terminal of the data writing circuit being electrically connected to the second terminal of the driving circuit. The data writing circuit is configured to write a data signal to the second terminal of the driver circuit, and includes a data writing transistor and a first compensation capacitor, a gate electrode of the data writing transistor being configured to receive the data scanning signal, and a first electrode of the first compensation capacitor being electrically connected to the first electrode of the data writing transistor.

### TECHNICAL FIELD

At least one embodiment of the present disclosure relates to a pixel circuit, a driving method thereof and a display device.

### BACKGROUND

With the continuous development of display technology, a pixel circuit using low temperature polycrystalline oxide (LTPO) has been increasingly used in display devices, a pixel circuit using LTPO has a high refresh rate, can achieve a low leakage current, and is conducive to making the brightness of a display panel more uniform. In addition, an internal compensation circuit is widely used because of the low requirements for a driving integrated circuit (IC), low cost and a simple control algorithm.

### SUMMARY

At least one embodiment of the disclosure provides a pixel circuit, a driving method thereof and a display device.

At least one embodiment of the disclosure provides a pixel circuit including a driving circuit and a data writing circuit. The driving circuit includes a control terminal, a first terminal and a second terminal, and configured to control a magnitude of a driving current flowing through the first terminal and the second terminal. The data writing circuit includes a first terminal and a second terminal, wherein the first terminal of the data writing circuit is electrically connected with the second terminal of the driving circuit, and the second terminal of the data writing circuit is configured to receive a data signal, the data writing circuit is configured to write the data signal to the second terminal of the driving circuit in response to a data scan signal, and comprises a data writing transistor and a first compensation capacitor, a gate electrode of the data writing transistor is configured to receive the data scan signal, and a first electrode of the first compensation capacitor is electrically connected with a first electrode of the data writing transistor.

For example, in the pixel circuit according to at least one embodiment of the disclosure, a second electrode of the first compensation capacitor is electrically connected with the second terminal of the driving circuit, and a second electrode of the data writing transistor is electrically connected with a data signal terminal to receive the data signal.

For example, in the pixel circuit according to at least one embodiment of the disclosure, a capacitance value of the first compensation capacitor is 30 times to 100 times a capacitance value of a parasitic capacitor between the gate electrode of the data writing transistor and the first electrode of the data writing transistor.

For example, in the pixel circuit according to at least one embodiment of the disclosure, the capacitance value of the first compensation capacitor is 100 fF to 300 fF.

For example, in the pixel circuit according to at least one embodiment of the disclosure, a second electrode of the first compensation capacitor is electrically connected with a data signal terminal to receive the data signal, and a second electrode of the data writing transistor is electrically connected with the second terminal of the driving circuit.

For example, the pixel circuit according to at least one embodiment of the disclosure further includes: a first reset circuit, wherein a control terminal of the first reset circuit is configured to receive a first reset control signal, a first terminal of the first reset circuit is electrically connected with the first electrode of the first compensation capacitor, a second terminal of the first reset circuit is electrically connected with a reference signal terminal to receive a reference signal, the first reset circuit is configured to write the reference signal to the second terminal of the driving circuit with the first compensation capacitor in response to the first reset control signal.

For example, in the pixel circuit according to at least one embodiment of the disclosure, the first reset circuit comprises a first reset transistor, a gate electrode of the first reset transistor is electrically connected with a first reset control terminal to receive the first reset control signal, a first electrode of the first reset transistor is electrically connected with the first electrode of the first compensation capacitor, and a second electrode of the first reset transistor is electrically connected with the reference signal terminal to receive the reference signal; the data writing transistor is multiplexed as the first reset transistor, and the data scan signal is multiplexed as the first reset control signal, the second electrode of the data writing transistor is further electrically connected with the reference signal terminal to receive the reference signal, and is configured to apply the reference signal to the second terminal of the driving circuit with the first compensation capacitor.

For example, in the pixel circuit according to at least one embodiment of the disclosure, the data signal terminal is multiplexed as the reference signal terminal, and is configured to receive the data signal and the reference signal respectively in different periods; or, the data signal terminal and the reference signal terminal are different signal terminals that are independent of each other.

For example, in the pixel circuit according to at least one embodiment of the disclosure, the first reset circuit comprises a first reset transistor, a gate electrode of the first reset transistor is electrically connected with a first reset control terminal to receive the first reset control signal, a first electrode of the first reset transistor is electrically connected with the first electrode of the first compensation capacitor, and a second electrode of the first reset transistor is electrically connected with the reference signal terminal to receive the reference signal; the data writing transistor and the first reset transistor are independently controlled transistors, respectively, the gate electrode of the data writing transistor is electrically connected with a data control terminal, the gate electrode of the first reset transistor is electrically connected with the first reset control terminal, the data control terminal and the first reset control terminal are different signal terminals that are independent of each other, and the data signal terminal and the reference signal terminal are different signal terminals that are independent of each other.

For example, the pixel circuit according to at least one embodiment of the disclosure further includes: a light-emitting element, configured to emit light driven by the driving current, wherein the second terminal of the driving circuit is electrically connected with a first electrode of the light-emitting element, and the driving circuit is configured to control a magnitude of a driving current flowing through the light-emitting element, a second electrode of the light-emitting element is electrically connected with a first voltage terminal to receive a first power supply voltage; a second reset circuit, wherein a control terminal of the second reset circuit is configured to receive a second reset control signal, a first terminal of the second reset circuit is electrically connected with the first electrode of the light-emitting element, and a second terminal of the second reset circuit is electrically connected with a first reset signal terminal to receive a first reset signal, and the second reset circuit is configured to apply the first reset signal to the first electrode of the light-emitting element in response to the second reset control signal.

For example, in the pixel circuit according to at least one embodiment of the disclosure, the second reset circuit comprises a second reset transistor, a gate electrode of the second reset transistor is electrically connected with a second reset control terminal to receive the second reset control signal, and a first electrode of the second reset transistor is electrically connected with the first electrode of the light-emitting element, and a second electrode of the second reset transistor is electrically connected with the first reset signal terminal to receive the first reset signal; the gate electrode of the data writing transistor is electrically connected with the gate electrode of the second reset transistor, the data writing transistor and the second reset transistor share a gate electrode, and the data scan signal serves as the second reset control signal, a type of the data transistor is the same as a type of the second reset transistor; or, the gate electrode of the data transistor and the gate electrode of the second reset transistor are independent of each other and not electrically connected.

For example, the pixel circuit according to at least one embodiment of the disclosure, further includes: a first light-emitting control circuit, wherein a control terminal of the first light-emitting control circuit is configured to receive a first light-emitting control signal, and a first terminal of the first light-emitting control circuit is electrically connected with the first terminal of the driving circuit, a second terminal of the first light-emitting control circuit is electrically connected with a second voltage terminal to receive a second power supply voltage, and the first light-emitting control circuit is configured to apply the second power supply voltage to the first terminal of the driving circuit in respond to the first light-emitting control signal; and a second light-emitting control circuit, wherein a control terminal of the second light-emitting control circuit is configured to receive a second light-emitting control signal, the second light-emitting control signal is different from the first light-emitting control signal, and a first terminal of the second light-emitting control circuit is electrically connected with the second terminal of the driving circuit, a second terminal of the second light-emitting control circuit is electrically connected with the first electrode of the light-emitting element, and the second light-emitting control circuit is configured to apply the driving current to the light-emitting element in response to the second light-emitting control signal.

For example, the pixel circuit according to at least one embodiment of the disclosure further includes: a direct reset circuit, a control terminal of the direct reset circuit is configured to receive a direct reset control signal, a first terminal of the direct reset circuit is electrically connected with the second terminal of the driving circuit, a second terminal of the direct reset circuit is electrically connected with a second reset signal terminal to receive a second reset signal, the direct reset circuit is configured to apply the second reset signal directly to the second terminal of the driving circuit in response to the direct reset control signal; the direct reset circuit comprises a direct reset transistor, a gate electrode of the direct reset transistor is electrically connected with a direct reset control signal terminal to receive the direct reset control signal, and a first electrode of the direct reset transistor is electrically connected with the second terminal of the driving circuit, a second terminal of the direct reset transistor is electrically connected with the second reset signal terminal to receive the second reset signal.

For example, in the pixel circuit according to at least one embodiment of the disclosure, a value of the first reset signal is equal to a value of the second reset signal.

For example, in the pixel circuit according to at least one embodiment of the disclosure, the first light-emitting control circuit comprises a first-emitting control transistor, a gate electrode of the first-emitting control transistor is electrically connected with a first light-emitting control terminal to receive the first light-emitting control signal, and a first electrode of the first light-emitting control transistor is electrically connected with the first terminal of the driving circuit, and a second electrode of the first light-emitting control transistor is electrically connected with the second voltage terminal to receive the second power supply voltage; the second light-emitting control circuit comprises a second light-emitting control transistor, a gate electrode of the second light-emitting control transistor is electrically connected with a second light-emitting control terminal to receive the second light-emitting control signal, and a first electrode of the second light-emitting control transistor is electrically connected with the second terminal of the driving circuit, and a second electrode of the second light-emitting control transistor is electrically connected with the first electrode of the light-emitting element.

For example, the pixel circuit according to at least one embodiment of the disclosure further includes: an auxiliary compensation circuit, comprising a second compensation capacitor, wherein a first electrode of the second compensation capacitor is electrically connected with the second terminal of the driving circuit, and a second electrode of the second compensation capacitor is configured to receive a first constant signal.

For example, in the pixel circuit according to at least one embodiment of the disclosure, a second electrode of the second compensation capacitor is electrically connected with the second voltage terminal, and the second power supply voltage serves as the first constant signal; or the second electrode of the second compensation capacitor is electrically connected with the first reset signal terminal, and the first reset signal serves as the first constant signal; or the second electrode of the second compensation capacitor is electrically connected with an external constant signal terminal outside the pixel circuit to receive the first constant signal from the external constant signal terminal.

For example, the pixel circuit according to at least one embodiment of the disclosure further includes: an auxiliary circuit, comprising an auxiliary capacitor, wherein a first electrode of the auxiliary capacitor is electrically connected with the gate electrode of the data writing transistor, and a second electrode of the auxiliary capacitor is configured to receive a second constant signal.

For example, the pixel circuit according to at least one embodiment of the disclosure further includes: a third reset circuit, wherein a control terminal of the third reset circuit is configured to receive a third reset control signal, a first terminal of the third reset circuit is electrically connected with the first terminal of the driving circuit, and a second terminal of the third reset circuit is electrically connected with the control terminal of the driving circuit, the third reset circuit is configured to allow the second power supply voltage to be applied to the control terminal of the driving circuit in response to the third reset control signal; and a compensation control circuit, comprising a compensation control capacitor, wherein a first electrode of the compensation control capacitor is electrically connected with the control terminal of the driving circuit, and a second electrode of the compensation control capacitor is electrically connected with the first electrode of the light-emitting element.

For example, in the pixel circuit according to at least one embodiment of the disclosure, the driving circuit comprises a driving transistor, a gate electrode of the driving transistor serves as the control terminal of the driving circuit, a first electrode of the driving transistor serves as the first terminal of the driving circuit, and a second electrode of the driving transistor serves as the second terminal of the driving circuit; the third reset circuit comprises a third reset transistor, a gate electrode of the third reset transistor is electrically connected with a third reset control terminal to receive the third reset control signal, a first electrode of the third reset transistor is electrically connected with the first electrode of the driving transistor, and a second electrode of the third reset transistor is electrically connected with the gate electrode of the driving transistor.

At least one embodiment of the disclosure provides a display device, comprising the pixel circuit according to any embodiments as mentioned above.

At least one embodiment of the disclosure provides a driving method of a pixel circuit, suitable for the pixel circuit according to any embodiments as mentioned above, the driving method comprising: in a data writing and compensation stage, making the data scan signal a turn-on signal to turn on the data writing transistor, and writing the data signal into the second terminal of the driving circuit through the data writing transistor and the first compensation capacitor.

For example, in the driving method of a pixel circuit according to at least one embodiment of the disclosure, the pixel circuit further comprises a data writing circuit, a control terminal of the data writing circuit is configured to receive a data scan signal, and a first terminal of the data writing circuit is electrically connected with the second terminal of the driving circuit, and a second terminal of the data writing circuit is electrically connected with a data signal terminal to receive the data signal; the driving method further comprises: in the data writing and compensation stage, making the data scan signal a turn-on signal to write the data signal to the second terminal of the driving circuit; and in the case of entering a light-emitting stage from the data writing and compensation stage, changing the data scan signal from the turn-on signal to a turn-off signal to turn off the data writing transistor, wherein in the light-emitting stage, the data scan signal remains as the turn-off signal.

For example, in the driving method of a pixel circuit according to at least one embodiment of the disclosure, during writing the data signal into the second terminal of the driving circuit through the data writing transistor and the first compensation capacitor, a difference between an initial voltage value Vc11 of the first electrode of the first compensation capacitor before entering the data writing and compensation stage and its stable voltage value Vc12 in the data writing and compensation stage is a first variation ΔVc1, a difference between an initial voltage value Vc13 of the second electrode of the first compensation capacitor before entering the data writing and compensation stage and its stable voltage value Vc14 in the data writing and compensation stage is a second variation ΔVc2, the first variation ΔVc1 is equal to the second variation ΔVc2.

For example, in the driving method of a pixel circuit according to at least one embodiment of the disclosure, the pixel circuit further comprises an auxiliary compensation circuit, the auxiliary compensation circuit comprises a second compensation capacitor, wherein a first electrode of the second compensation capacitor is electrically connected with the second terminal of the driving circuit, and a second electrode of the second compensation capacitor is configured to receive a first constant signal; during writing the data signal into the second terminal of the driving circuit through the data writing transistor and the first compensation capacitor, the first compensation capacitor is connected in series with the second compensation capacitor, in the data writing and compensation stage, a voltage Vc3 of the second terminal of the driving circuit is equal to (Vdata−Vref)×[C1/(C1+C2)]+Vini1, Vdata represents a value of the data signal, Vref represents an initial voltage value of the first electrode of the first compensation capacitor before entering the data writing and compensation stage, and C1 represents a capacitance value of the first compensation capacitor, C2 represents a capacitance value of the second compensation capacitor, and Vini1 represents an initial voltage value of the second terminal of the driving circuit before entering the data writing and compensation stage.

For example, in the driving method of a pixel circuit according to at least one embodiment of the disclosure, the pixel circuit further comprises: a light-emitting element, a first reset circuit, a second reset circuit, a third reset circuit, a first light-emitting control circuit and a second light-emitting control circuit, the second terminal of the driving circuit is electrically connected with a first electrode of the light-emitting element, and the driving circuit is configured to control a magnitude of the driving current flowing through the light-emitting element; a control terminal of the first reset circuit is configured to receive a first reset control signal, a first terminal of the first reset circuit is electrically connected with the first electrode of the first compensation capacitor, a second terminal of the first reset circuit is electrically connected with a reference signal terminal to receive a reference signal; a control terminal of the second reset circuit is configured to receive a second reset control signal, and a first terminal of the second reset circuit is electrically connected with the first electrode of the light-emitting element, a second terminal of the second reset circuit is electrically connected with a first reset signal terminal to receive a first reset signal; a control terminal of the third reset circuit is configured to receive a third reset control signal, a first terminal of the third reset circuit is electrically connected with the first terminal of the driving circuit, and a second terminal of the third reset circuit is electrically connected with the control terminal of the driving circuit; a control terminal of the first light-emitting control circuit is configured to receive a first light-emitting control signal, a first terminal of the first light-emitting control circuit is electrically connected with the first terminal of the driving circuit, a second terminal of the first light-emitting control circuit is electrically connected with a second voltage terminal to receive a second power supply voltage; a control terminal of the second light-emitting control circuit is configured to receive a second light-emitting control signal, and a first terminal of the second light-emitting control circuit is electrically connected with the second terminal of the driving circuit, and a second terminal of the second light-emitting control circuit is electrically connected with the first electrode of the light-emitting element, the driving method further comprises: in a reset stage before the data compensation stage, making the first reset control signal a turn-on signal to turn on the first reset circuit, wherein the first reset circuit applies the reference signal to the first electrode of the first compensation capacitor; making the first light-emitting control signal a turn-on signal to turn on the first light-emitting control circuit, wherein the first light-emitting control circuit applies the second power supply voltage to the first terminal of the driving circuit; making the third reset control signal a turn-on signal to turn on the third reset circuit, wherein the third reset circuit applies the second power supply voltage to the control terminal of the driving circuit; making the second reset control signal a turn-on signal to turn on the second reset circuit, wherein the second reset circuit applies the first reset signal to the first electrode of the light-emitting element; and making the second light-emitting control signal a turn-on signal to turn on the second light-emitting control circuit; wherein the first reset signal is applied to the second terminal of the driving circuit through the second light-emitting control circuit, and a value of the first reset signal is Vini1, so that an initial voltage value of the second terminal of the driving circuit before entering the data writing and compensation stage is Vini1; and/or, the pixel circuit further comprises a direct reset circuit, a control terminal of the direct reset circuit is configured to receive a direct reset control signal, a first terminal of the direct reset circuit is electrically connected with the second terminal of the driving circuit, the second terminal of the direct reset circuit is electrically connected with a second reset signal terminal to receive the second reset signal; in the light-emitting stage, the driving method further comprises: making the direct reset control signal a turn-on signal to turn on the direct reset signal circuit, wherein the second reset signal is applied to the second terminal of the driving circuit, and a value of the second reset signal is Vini2, so that an initial voltage value of the second terminal of the driving circuit before entering the data writing and compensation stage is Vini2.

For example, in the driving method of a pixel circuit according to at least one embodiment of the disclosure, the pixel circuit further comprises a compensation control circuit, the compensation control circuit comprises a compensation control capacitor, wherein a first electrode of the compensation control capacitor is electrically connected with the gate electrode of the driving transistor, and a second electrode of the compensation control capacitor is electrically connected with the first electrode of the light-emitting element; the driving method further comprises: during the data writing and compensation stage, making the second reset control signal a turn-on signal to turn on the second reset circuit, wherein the second reset circuit applies the first reset signal to the first electrode of the light-emitting element and the second electrode of the compensation control capacitor.

### BRIEF DESCRIPTION OF DRAWINGS

In order to clearly illustrate the technical solution of the embodiments of the disclosure, the drawings of the embodiments are briefly described in the following; it is understood that the drawings described relate only to some embodiments of the disclosure and are therefore not limiting of the disclosure.

FIG. 1 is a schematic block diagram of a pixel circuit provided by at least one embodiment of the present disclosure.

FIG. 2A is a circuit diagram of an implementation example of the pixel circuit as illustrated in FIG. 1.

FIG. 2B is a schematic diagram of the pixel circuit as illustrated in FIG. 2A when it is in a data writing and compensation stage.

FIG. 2C is a schematic diagram of the pixel circuit as illustrated in FIG. 2A when it is in a light-emitting stage.

FIG. 3 is a signal timing diagram of a driving method provided by at least one embodiment of the present disclosure.

FIG. 4 is a schematic block diagram of another pixel circuit provided by at least one embodiment of the present disclosure.

FIG. 5A is a circuit diagram of an implementation example of the pixel circuit as illustrated in FIG. 4.

FIG. 5B is a schematic diagram of the pixel circuit as illustrated in FIG. 5A when it is in a data writing and compensation stage.

FIG. 5C is a schematic diagram of the pixel circuit as illustrated in FIG. 5A when it is in a light-emitting stage.

FIG. 6 is a signal timing diagram of another driving method provided by at least one embodiment of the present disclosure.

FIG. 7 is a schematic block diagram of another pixel circuit provided by at least one embodiment of the present disclosure.

FIG. 8A is a circuit diagram of an implementation example of the pixel circuit as illustrated in FIG. 7.

FIG. 8B is a schematic diagram of the pixel circuit as illustrated in FIG. 8A when it is in a reset stage.

FIG. 8C is a schematic diagram of the pixel circuit as illustrated in FIG. 8A when it is in a data writing and compensation stage.

FIG. 8D is a schematic diagram of the pixel circuit as illustrated in FIG. 8A when it is in a light-emitting stage.

FIG. 9 is a signal timing diagram of another driving method provided by at least one embodiment of the present disclosure.

FIG. 10 is a schematic block diagram of another pixel circuit provided by at least one embodiment of the present disclosure.

FIG. 11A is a circuit diagram of an implementation example of the pixel circuit as illustrated in FIG. 10.

FIG. 11B is a schematic diagram of the pixel circuit as illustrated in FIG. 11A when it is in a reset stage.

FIG. 11C is a schematic diagram of the pixel circuit as illustrated in FIG. 11A when it is in a data writing and compensation stage.

FIG. 11D is a schematic diagram of the pixel circuit as illustrated in FIG. 11A when it is in a light-emitting stage.

FIG. 12 is a signal timing diagram of another driving method provided by at least one embodiment of the present disclosure.

FIG. 13 is a schematic block diagram of another pixel circuit provided by at least one embodiment of the present disclosure.

FIG. 14A is a circuit diagram of an implementation example of the pixel circuit as illustrated in FIG. 13.

FIG. 14B is a schematic diagram of the pixel circuit as illustrated in FIG. 13 when it is in a data writing and compensation stage.

FIG. 14C is a schematic diagram of the pixel circuit as illustrated in FIG. 13 when it is in a light-emitting stage.

FIG. 15 is a schematic block diagram of another pixel circuit provided by at least one embodiment of the present disclosure.

FIG. 16 is a circuit diagram of an implementation example of the pixel circuit as illustrated in FIG. 15.

FIG. 17 is a schematic block diagram of another pixel circuit provided by at least one embodiment of the present disclosure.

FIG. 18 is a circuit diagram of an implementation example of the pixel circuit as illustrated in FIG. 17.

FIG. 19 is a circuit diagram of another implementation example of the pixel circuit as illustrated in FIG. 1.

FIG. 20 is a schematic block diagram of a display device provided by at least one embodiment of the present disclosure.

### DETAILED DESCRIPTION

In order to make the purpose, technical solutions and advantages of the embodiments of the present disclosure clearer, the technical solutions of the embodiments of the present disclosure will be described clearly and completely in the following in conjunction with the accompanying drawings of the embodiments of the present disclosure. Obviously, the described embodiments are a part of the embodiments of the present disclosure, and not all of the embodiments. Based on the described embodiments of the present disclosure, all other embodiments obtained by a person of ordinary skill in the art without the need for creative labor fall within the scope of protection of the present disclosure.

Unless otherwise defined, technical or scientific terms used in the present disclosure shall have the ordinary meaning understood by a person of ordinary skill in the field to which the present disclosure belongs. The terms “first”, “second”, and the like as used in the present disclosure do not indicate any order, number, or significance, but are only used to distinguish different components. Words such as “including” or “comprising” and the like are intended to mean that the component or object preceded by the word encompasses the component or object enumerated after the word and its equivalents, and does not exclude other components or objects.

As used in embodiments of the present disclosure, the features such as “perpendicular”, “parallel”, and “identical” include the strict meaning of “perpendicular”, “parallel”, and “identical”, as well as “substantially perpendicular”, “substantially parallel”, “substantially identical” that include a certain amount of error, taking into account the measurement and the error associated with the measurement of the particular quantity (i.e., the limitations of the measurement system), indicating to be within a range of acceptable deviations for the particular value as determined by a person of ordinary skill in the art. “Center” in embodiments of the present disclosure may include a position strictly at the geometric center as well as a position approximately at the center within a small area around the geometric center.

Generally, in a pixel circuit, a first electrode of a data writing transistor can be electrically connected with a first electrode of a driving transistor, so that a data signal can be written into the first electrode of the driving transistor. During a driving process of the pixel circuit, in the case where the pixel circuit enters a light-emitting stage, the data writing transistor will be switched from a turn-on state to a turn-off state. However, because a parasitic capacitor exists between a gate electrode of the data writing transistor and the first electrode of the data writing transistor, at the moment when the data writing transistor is turned off, the voltage of the first electrode of the data writing transistor may be decreased, thereby reducing the voltage of the first electrode of the driving transistor, which in turn causes a gate-source voltage Vgs of the driving transistor to decrease during the light-emitting stage, and affects the magnitude of the driving current.

For example, in the case where the gate-source voltages Vgs of the driving transistors of a plurality of sub-pixels in the display panel are reduced to different degrees when entering the light-emitting stage, the brightness of the plurality of sub-pixels will be different, which will affect the brightness uniformity of an entire display panel. In addition, because the pixel circuit includes a plurality of transistors, a plurality of capacitors, and a plurality of signal lines, an internal compensation structure of the pixel circuit is complicated. For example, some signal lines may have parasitic capacitor between each of them and the first electrode of the driving transistor. In the case where voltage signals of these signal lines change, the voltage of the first electrode of the driving transistor may fluctuate, causing crosstalk, for example, the light-emitting element may suddenly emit light, thereby causing the display panel to have abnormal images and affecting a display effect.

At the same time, some display devices may have a short-term residual image when displaying, that is, after the display device has displayed the same image for a period of time, in the case where the currently displayed image is switched to a next image, the original image partially remains and appears in the next image, and then after a period of time, the short-term residual image disappears. A reason for the short-term residual image may be that the driving transistor in the pixel circuit has a hysteresis effect, the hysteresis effect is mainly caused by a shift of a threshold voltage (Vth) caused by movable ions remaining in holes. When the display device switches images, the gate-source voltage Vgs (a voltage difference between the gate electrode and a source electrode of the driving transistor) of the driving transistor may be different, so the threshold voltage of the driving transistor may be shifted. For example, after the display device has displayed an initial image for a period of time, when the display device switches to a new image, the initial image remains partially for several hours, thus affecting the displaying effect. For example, during a low-gray-scale driving process, the gate-source voltage Vgs of the driving transistor is easily fluctuated by the shift of its threshold voltage (Vth).

At least one embodiment of the present disclosure provides a pixel circuit, a driving method thereof, and a display device.

At least one embodiment of the present disclosure provides a pixel circuit including a driving circuit and a data writing circuit, the driving circuit includes a control terminal, a first terminal and a second terminal, and is configured to control a magnitude of a driving current flowing through the first terminal and the second terminal; the data writing circuit includes a first terminal and a second terminal, the first terminal of the data writing circuit is electrically connected with the second terminal of the driving circuit, the second terminal of the data writing circuit is configured to receive a data signal, and the data writing circuit is configured to write the data signal to the second terminal of the driving circuit in response to a data scan signal, and includes a data writing transistor and a first compensation capacitor, a gate electrode of the data writing transistor is configured to receive the data scan signal, and a first electrode of the first compensation capacitor is electrically connected with a first electrode of the data writing transistor.

The pixel circuit provided by at least one embodiment of the present disclosure can reduce an impact of the data writing transistor on the voltage of the second terminal of the driving circuit in the case where the pixel circuit is switched to the light-emitting stage by electrically connecting the first electrode of the first compensation capacitor with the first electrode of the data writing transistor, the gate-source voltage Vgs of the driving transistor fluctuates less during the light-emitting stage, thereby improving the brightness uniformity of the display panel. In addition, it can further reduce an effect on the voltage of the second terminal of the driving circuit due to the fluctuation of the data writing signal. Therefore, the pixel circuit provided by the embodiment of the present disclosure is of great significance for stabilizing the gate-source voltage Vgs of the driving circuit and improving the display effect of the display device.

The pixel circuit, the driving method thereof, and the display device provided by embodiments of the present disclosure will be described below with reference to the accompanying drawings.

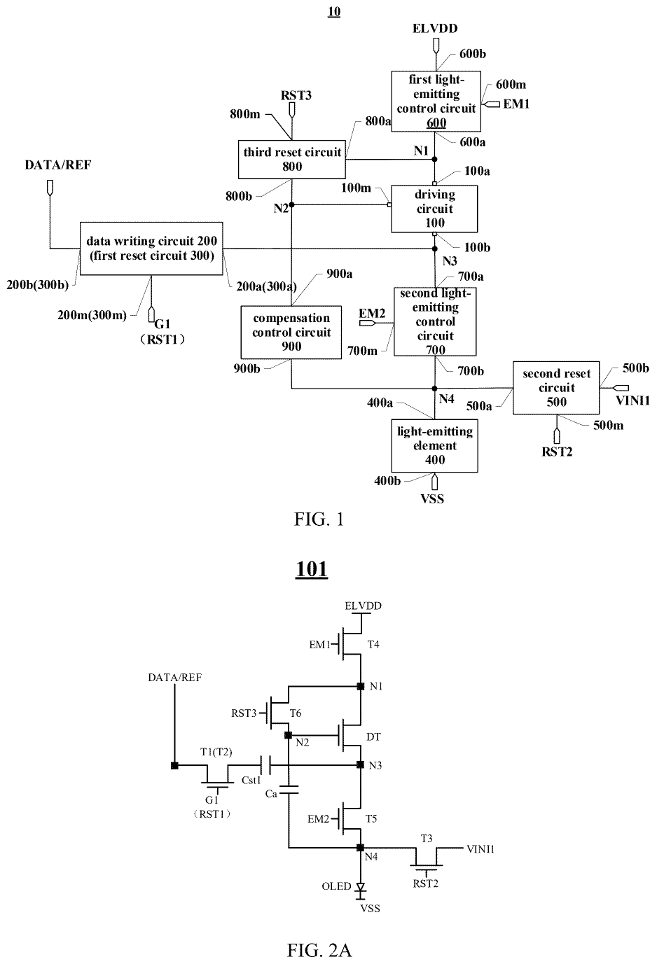

FIG. 1 is a schematic block diagram of a pixel circuit provided by at least one embodiment of the present disclosure.

As illustrated in FIG. 1, a pixel circuit 10 includes a driving circuit 100, a data writing circuit 200 (a first reset circuit 300), a light-emitting element 400, a second reset circuit 500, a first light-emitting control circuit 600, a second light-emitting control circuit 700, a third reset circuit 800 and a compensation control circuit 900.

As illustrated in FIG. 1, the driving circuit 100 includes a control terminal 100m, a first terminal 100a and a second terminal 100b, the first terminal 100a of the driving circuit 100 is electrically connected with a first node N1, and the control terminal 100m of the driving circuit 100 is electrically connected with a second node N2, and the second terminal 100b of the driving circuit 100 is electrically connected with a third node N3. The driving circuit 100 is configured to control a magnitude of a driving current flowing through the first terminal 100a and the second terminal 100b, for example, the driving current can be configured to drive the light-emitting element 400 to emit light. For example, in a light-emitting stage, the driving circuit 100 can provide the driving current to the light-emitting element 400 to drive the light-emitting element 400 to emit light, and the light-emitting element 400 can emit light according to a required “grayscale”.

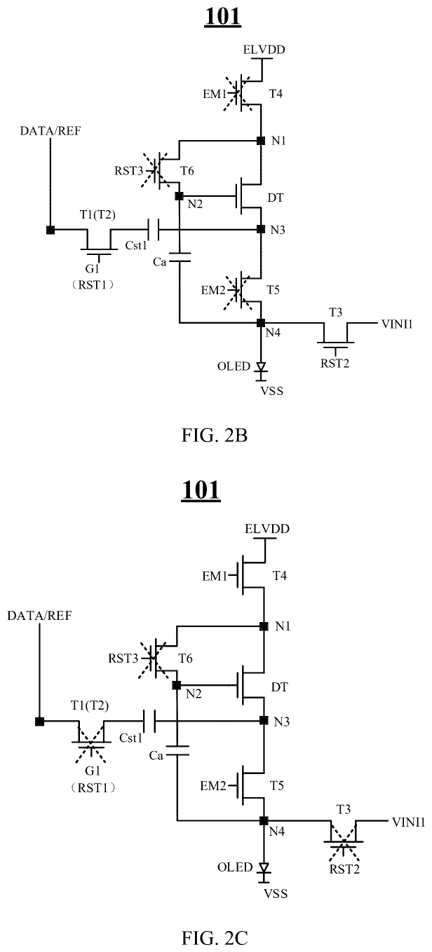

As illustrated in FIG. 1, the data writing circuit 200 includes a control terminal 200m, a first terminal 200a and a second terminal 200b. The control terminal 200m of the data writing circuit 200 is configured to receive a data scan signal G1, the first terminal 200a of the data writing circuit 200 is electrically connected with the second terminal 100b of the driving circuit 100, the second terminal 200b of the data writing circuit 200 is electrically connected with a data signal terminal DATA to receive a data signal DATA. The data writing circuit 200 includes a data writing transistor T1 and a first compensation capacitor Cst1 (refer to FIG. 2A), and a gate electrode of the data writing transistor T1 is configured to receive the data scan signal G1 and a first electrode of the first compensation capacitor Cst1 is electrically connected with a first electrode of the data writing transistor T1. For example, in a data writing and compensation stage, the data writing circuit 200 is turned on in response to the data scan signal G1, and the data writing transistor T1 cooperates with the first compensation capacitor Cst1 to write the data signal DATA to the second terminal 100b of the driving circuit 100.

As illustrated in FIG. 1, the first reset circuit 300 includes a control terminal 300m, a first terminal 300a and a second terminal 300b. The control terminal 300m of the first reset circuit 300 is configured to receive a first reset control signal RST1, and the first terminal 300a of the first reset circuit 300 is electrically connected with the second terminal 100b of the driving circuit 100; the first reset circuit 300 includes a first reset transistor T2, here, the data writing transistor T1 is multiplexed as the first reset transistor T2, a first electrode of the first reset transistor T2 is electrically connected with the first electrode of the first compensation capacitor Cst1; the second terminal 300b of the first reset circuit 300 is electrically connected with a reference signal terminal REF for receiving a reference signal REF, the first reset circuit 300 is configured to write the reference signal REF to the second terminal 100b of the driving circuit 100 with the first compensation capacitor Cst1 in response to the first reset control signal RST1. For example, the reference signal REF may be a reference voltage. For example, in some embodiments of the present disclosure, as illustrated in FIG. 1, the first reset circuit 300 includes the first reset transistor T2 (see FIG. 2A), and the data writing transistor T1 can be multiplexed as the first reset transistor T2 to simplify a structure of the pixel circuit. For example, in some embodiments, the data writing circuit 200 and the first reset circuit 300 can further be independent of each other and controlled separately, and can be specifically set according to design requirements, which is not limited in the embodiments of the present disclosure.

As illustrated in FIG. 1, the light-emitting element 400 includes a first electrode 400a and a second electrode 400b, and the light-emitting element 400 is configured to emit light upon being driven by the driving current. The second terminal 100b of the driving circuit 100 is electrically connected with the first electrode 400a of the light-emitting element 400, and the driving circuit 100 is configured to control a magnitude of the driving current flowing through the light-emitting element 400. For example, in one example, as illustrated in FIG. 1, the first electrode 400a of the light-emitting element 400 is electrically connected with a fourth node N4, and the light-emitting element 400 can be electrically connected with the second terminal 100b of the driving circuit 100 through the second light-emitting control circuit 700, the embodiments of the present disclosure include but are not limited to this situation. The second electrode 400b of the light-emitting element 400 is electrically connected with a first voltage terminal VSS to receive a first power supply voltage VSS. For example, the first voltage terminal VSS may be grounded, that is, the first power supply voltage VSS may be OV. For example, the first power supply voltage VSS may be a negative voltage. For example, the light-emitting element can be implemented as a light-emitting diode (LED), such as an organic light-emitting diode (OLED), a quantum dot light-emitting diode (QLED), or an inorganic light-emitting diode, for example, the light-emitting element can be a micro light-emitting diode (micro LED) or a micro OLED, and the embodiments of the present disclosure do not limit a type of the light-emitting element.

The second reset circuit 500 includes a control terminal 500m, a first terminal 500a and a second terminal 500b. The control terminal 500m of the second reset circuit 500 is configured to receive a second reset control signal RST2, the first terminal 500a of the second reset circuit 500 is electrically connected with the first electrode 400a of the light-emitting element 400, the second terminal 500b of the second reset circuit 500 is electrically connected with a first reset signal terminal VINI1 to receive a first reset signal VINI1, the second reset circuit 500 is configured to apply the first reset signal VINI1 to the first electrode 400a of the light-emitting element 400 and the second terminal 100b of the driving circuit 100 in response to the second reset control signal RST2, thereby achieving a reset operation.

The first light-emitting control circuit 600 includes a control terminal 600m, a first terminal 600a and a second terminal 600b. The control terminal 600m of the first light-emitting control circuit 600 is configured to receive a first light-emitting control signal EM1, the first terminal 600a of the first light-emitting control circuit 600 is electrically connected with the first terminal 100a of the driving circuit 100, the second terminal 600b of the first light-emitting control circuit 600 is electrically connected with a second voltage terminal ELVDD to receive a second power supply voltage ELVDD, and the first light-emitting control circuit 600 is configured to apply the second power supply voltage ELVDD to the first terminal 100a of the driving circuit 100 in response to the first light-emitting control signal EM1. For example, in a reset stage, the first light-emitting control circuit 600 may be turned on in response to the first light-emitting control signal EM1, so that the second power supply voltage ELVDD may be applied to the first terminal 100a of the driving circuit 100. For example, in the light-emitting stage, the first light-emitting control circuit 600 can further be turned on in response to the first light-emitting control signal EM1, so that the second power supply voltage ELVDD can be applied to the first terminal 100a of the driving circuit 100, and in the case where the driving circuit 100 is turned on, the second power supply voltage ELVDD is written into the second terminal 100b of the driving circuit 100. The second terminal 400b of the light-emitting element 400 receives the first power supply voltage VSS, and the light-emitting element 400 emits light under an action of the second power supply voltage ELVDD and the first power supply voltage VSS. For example, the second power supply voltage ELVDD may be a high voltage, and the first power supply voltage VSS may be a low voltage, but the embodiments of the present disclosure are not limited thereto.

As illustrated in FIG. 1, the second light-emitting control circuit 700 includes a control terminal 700m, a first terminal 700a and a second terminal 700b. The control terminal 700m of the second light-emitting control circuit 700 is configured to receive a second light-emitting control signal EM2, the first terminal 700a of the second light-emitting control circuit 700 is electrically connected with the second terminal 100b of the driving circuit 100, the second terminal 700b of the second light-emitting control circuit 700 is electrically connected with the first electrode 400a of the light-emitting element 400, and the second light-emitting control circuit 700 is configured to apply the driving current to the light-emitting element 400 in response to the second light-emitting control signal EM2 and allow the first reset signal VINI1 to pass through the second light-emitting control circuit 700 and be applied to the second terminal 100b of the driving circuit 100. For example, during the light-emitting stage, the second light-emitting control circuit 700 is turned on in response to the second light-emitting control signal EM2, so that the driving circuit 100 can apply the driving current to the light-emitting element 400 through the second light-emitting control circuit 700 to make the light-emitting element 400 emit light. For example, in the reset stage, the second light-emitting control circuit 700 may further be turned on in response to the second light-emitting control signal EM2, thereby being combined with other circuit elements (for example, the second reset circuit 500) to allow the first reset signal VINI1 to be applied to the second terminal 100b of the driving circuit 100 to realize the reset operation of the driving circuit 100 and the light-emitting element 400. For example, in the data writing and compensation stage, the second light-emitting control circuit 700 is turned off in response to the second light-emitting control signal EM2, thereby preventing the light-emitting element 400 from emitting light to improve a contrast of a corresponding display device. For example, the first reset signal VINI1 may be a first reset voltage.

For example, as illustrated in FIG. 1, the second light-emitting control signal EM2 is different from the first light-emitting control signal EM1, for example, the two can be electrically connected with different signal output terminals. For example, in the reset stage and the light-emitting stage, the first light-emitting control signal EM1 and the second light-emitting control signal EM2 are turn-on signals at the same time. For example, in the data writing and compensation stage, the first light-emitting control signal EM1 and the second light-emitting control signal EM2 are turn-off signals at the same time to prevent the light-emitting element 400 from emitting light. For example, in some embodiments of the present disclosure, the first light-emitting control circuit 600 and the second light-emitting control circuit 700 may share a same control terminal to simplify the structure of the pixel circuit and simplify a control method, the embodiments of the present disclosure do not limit this.

As illustrated in FIG. 1, the third reset circuit 800 includes a control terminal 800m, a first terminal 800a and a second terminal 800b. The control terminal 800m of the third reset circuit 800 is configured to receive a third reset control signal RST3, the first terminal 800a of the third reset circuit 800 is electrically connected with the first terminal 100a of the driving circuit 100, the second terminal 800b of the third reset circuit 800 is electrically connected with the control terminal 100m of the driving circuit 100, and the third reset circuit 800 is configured to allow the second power supply voltage ELVDD to be applied to the control terminal 100m of the driving circuit 100 in response to the third reset control signal RST3. For example, in the reset stage, the third reset circuit 800 is turned on in response to the third reset control signal RST3, so that the second power supply voltage ELVDD can be applied to the control terminal 100m of the driving circuit 100, thereby realizing the reset of the driving circuit 100.

As illustrated in FIG. 1, the compensation control circuit 900 includes a first terminal 900a and a second terminal 900b, the first terminal 900a of the compensation control circuit 900 is electrically connected with the control terminal 100m of the driving circuit 100, the second terminal 900b of the compensation control circuit 900 is electrically connected with the first electrode 400a of the light-emitting element 400. For example, the compensation control circuit 900 may include a compensation control capacitor Ca (as illustrated in FIG. 2A), a first electrode of the compensation control capacitor Ca is connected with the control terminal 100m of the driving circuit 100, and a second electrode of the compensation control capacitor Ca is electrically connected with the first electrode 400a of the light-emitting element 400. For example, when entering the light-emitting stage from the data writing and compensation stage, in the case where a voltage of the first electrode 400a of the light-emitting element 400 increases, the compensation control capacitor Ca can exert a bootstrap function, thereby enabling a voltage of the control terminal 100m of the driving circuit 100 to increase to facilitate the driving circuit 100 to be in the turn-on state, thereby causing the light-emitting element 400 to emit light.

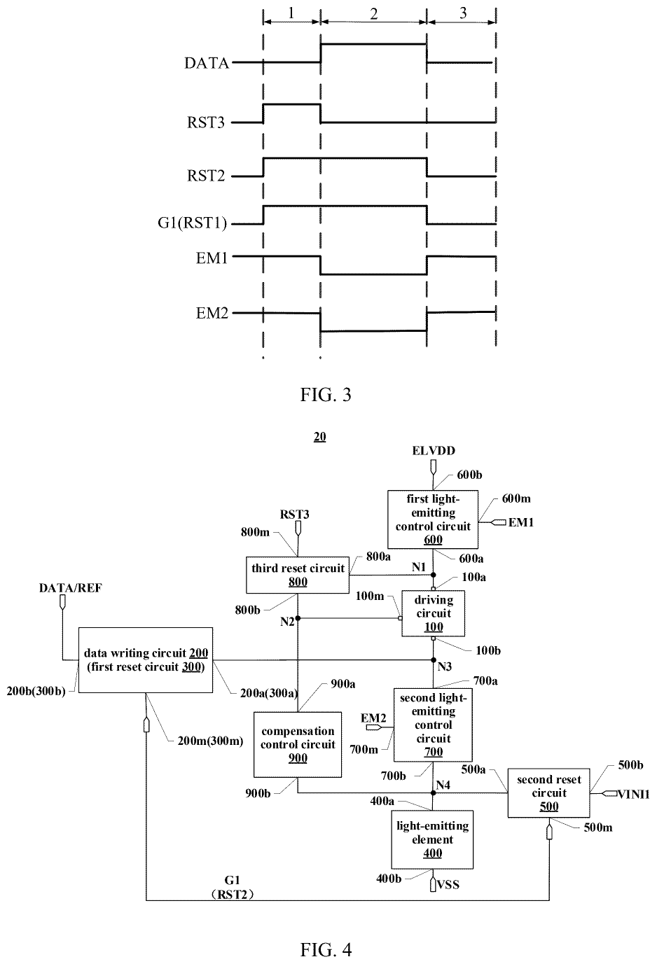

FIG. 2A is a circuit diagram of an implementation example of the pixel circuit as illustrated in FIG. 1; FIG. 3 is a signal timing diagram of a driving method provided by at least one embodiment of the present disclosure.

For example, the pixel circuit as illustrated in FIG. 1 can be implemented as a pixel circuit structure as illustrated in FIG. 2A. As illustrated in FIG. 2A, the pixel circuit 101 includes: a driving transistor DT, a data writing transistor T1 (a first reset transistor T2), a second reset transistor T3, a first light-emitting control transistor T4, a second light-emitting control transistor T5, a third reset transistor T6, a first compensation capacitor Cst1, a compensation control capacitor Ca and a light-emitting element OLED. For example, the data writing transistor T1 (the first reset transistor T2), the first reset transistor T2, the second reset transistor T3, the first light-emitting control transistor T4, the second light-emitting control transistor T5, and the third reset transistor T6 are configured as switching transistors. For example, the embodiments of the present disclosure are described by taking that the light-emitting element is the OLED as an example, but it is not limited thereto. For example, the light-emitting element may further be other light-emitting devices, which are not limited in the embodiments of the present disclosure. For example, in the case where the light-emitting element is the OLED, the light-emitting element can be of various types, such as top emission, bottom emission or the like, for example, the light-emitting element can emit red light, green light, blue light, or white light or the like, the embodiments of the present disclosure do not limit this.

For example, as illustrated in FIG. 1 and FIG. 2A, the driving circuit 100 includes the driving transistor DT, a first electrode of the driving transistor DT serves as the first terminal 100a of the driving circuit 100 and is electrically connected with the first node N1; a gate electrode of the driving transistor DT serves as the control terminal 100m of the driving circuit 100 and is electrically connected with the second node N2; a second electrode of the driving transistor DT serves as the second terminal 100b of the driving circuit 100 and is electrically connected with the third node N3.

For example, as illustrated in FIG. 1 and FIG. 2A, the data writing circuit 200 includes the data writing transistor T1 and the first compensation capacitor Cst1, the gate electrode of the data writing transistor T1 is electrically connected with the data scan signal terminal G1 to receive the data scan signal G1, the first electrode of the data writing transistor T1 is electrically connected with the first electrode of the first compensation capacitor Cst1, a second electrode of the data writing transistor T1 is electrically connected with the data signal terminal DATA to receive the data signal DATA, a second electrode of the first compensation capacitor Cst1 is electrically connected with the second electrode of the driving transistor DT.

For example, as illustrated in FIG. 1 and FIG. 2A, the first reset circuit 300 includes the first reset transistor T2, a gate electrode of the first reset transistor T2 is electrically connected with the first reset control terminal RST1 to receive the first reset control signal RST1, the first electrode of the first reset transistor T2 is electrically connected with the first electrode of the first compensation capacitor Cst1, and a second electrode of the first reset transistor T2 is electrically connected with the reference signal terminal REF to receive the reference signal REF.

For example, as illustrated in FIG. 1 and FIG. 2A, the data writing transistor T1 is multiplexed as the first reset transistor T2, and the data scan signal G1 is multiplexed as the first reset control signal RST1. The second electrode of the data writing transistor T1 is further electrically connected with the reference signal terminal REF to receive the reference signal REF, and is configured to apply the reference signal REF to the second terminal 100b of the driving circuit 100 with the first compensation capacitor Cst1. For example, in the pixel circuit 101 as illustrated in FIG. 2A, the data signal terminal DATA is multiplexed as the reference signal terminal REF, and the data signal terminal DATA is configured to receive the data signal DATA and the reference signal REF respectively in different periods of time, so that the data signal terminal DATA can receive different signals in different periods of time respectively according to the working requirements of the pixel circuit, thereby simplifying the structure of the pixel circuit.

For example, in some embodiments of the present disclosure, referring to reference to FIG. 1 and FIG. 2A, the data signal terminal DATA and the reference signal terminal REF can further be different signal terminals that are independent of each other, and the data signal terminal DATA and the reference signal terminal REF can be both electrically connected with the second electrode of the data writing transistor T1. For example, in different periods of time, the data signal terminal DATA can apply the data signal DATA to the second electrode of the data writing transistor T1, and the reference signal terminal REF can apply the reference signal REF to the second electrode of the data writing transistor T1, so that the control method of the pixel circuit is more flexible.

For example, as illustrated in FIG. 1 and FIG. 2A, the second reset circuit 500 includes the second reset transistor T3, a gate electrode of the second reset transistor T3 is electrically connected with a second reset control terminal RST2 to receive the second reset control signal RST2, a first electrode of the second reset transistor T3 is electrically connected with a first electrode of the light-emitting element OLED, and a second electrode of the second reset transistor T3 is electrically connected with the first reset signal terminal VINI1 to receive the first reset signal VINI1.

For example, as illustrated in FIG. 1 and FIG. 2A, the first light-emitting control circuit 600 includes the first light-emitting control transistor T4, a gate electrode of the first light-emitting control transistor T4 is electrically connected with a first light-emitting control terminal EM1 to receive the first light-emitting control signal EM1, a first electrode of the first light-emitting control transistor T4 is electrically connected with the first terminal 100a of the driving circuit 100 (the first electrode of the driving transistor DT), and a second electrode of the first light-emitting control transistor T4 is electrically connected with the second voltage terminal ELVDD to receive the second supply voltage ELVDD.

For example, as illustrated in FIG. 1 and FIG. 2A, the second light-emitting control circuit 700 includes the second light-emitting control transistor T5, a gate electrode of the second light-emitting control transistor T5 is electrically connected with a second light-emitting control terminal EM2 to receive the second light-emitting control signal EM2, a first electrode of the second light-emitting control transistor T5 is electrically connected with the second terminal 100b of the driving circuit 100 (the second electrode of the driving transistor DT), and a second electrode of the second light-emitting control transistor T5 is electrically connected with a first electrode of the light-emitting element OLED.

For example, as illustrated in FIG. 1 and FIG. 2A, the third reset circuit 800 includes a third reset transistor T6, a gate electrode of the third reset transistor T6 is electrically connected with a third reset control terminal RST3 to receive the third reset control signal RST3, a first electrode of the third reset transistor T6 is electrically connected with the first electrode (the first node N1) of the driving transistor DT, and a second electrode of the third reset transistor T6 is electrically connected with the gate electrode (the second node N2) of the driving transistor DT.

For example, as illustrated in FIG. 1 and FIG. 2A, a first electrode of the compensation control capacitor Ca is electrically connected with the gate electrode (second node N2) of the driving transistor DT, and a second electrode of the compensation control capacitor Ca is electrically connected with the first electrode of the light-emitting element OLED (the fourth node N4).

For example, as illustrated in FIG. 1 and FIG. 2A, the light-emitting element 400 can be implemented as an organic light-emitting diode (OLED). In the embodiments described below, the light-emitting element is an OLED as an example, the embodiments of the present disclosure include but are not limited to this. The light-emitting element can further be other types of electroluminescent devices such as an inorganic light-emitting diode, the embodiments of the present disclosure do not limit the type of the light-emitting element.

It should be noted that in the description of the embodiments of the present disclosure, the first node N1, the second node N2, the third node N3 and the fourth node N4 do not necessarily represent actual existing components, but represent meeting points of relevant circuit connections in the circuit diagram. In the description of the embodiments of the present disclosure, the symbol DATA can represent both the data signal terminal and the data signal; similarly, the symbol G1 can represent both the data scan signal terminal and the data scan signal; the symbol REF can represent both the reference signal terminal and the reference signal; the symbol RST1 can represent both the first reset control signal terminal and the first reset control signal; the symbol RST2 can represent both the second reset control signal terminal and the second reset control signal; the symbol RST3 can represent both the third reset control signal terminal and the third reset control signal; the symbol VSS can represent both the first voltage terminal and the first power supply voltage; the symbol ELVDD can represent both the second voltage terminal and the second power supply voltage; the symbol EM1 can represent both the first light-emitting control terminal and the first light-emitting control signal; the symbol EM2 can represent both the second light-emitting control terminal and the second light-emitting control signal; the symbol VINI1 can represent both the first reset signal terminal and the first reset signal; the symbol VINI2 can represent both the second reset signal terminal and the second reset signal, the following embodiments are the same and will not be described again.

It should be noted that the transistors used in the embodiments of the present disclosure may be thin film transistors, field-effect transistors, or other switching devices with the same characteristics, and the thin film transistors are taken as an example to be illustrated in the embodiments of the present disclosure. A source electrode and a drain electrode of the transistor adopted herein may be symmetric in structure, so there is no difference between the source electrode and the drain electrode in structure. In the embodiments of the present disclosure, in order to distinguish the two electrodes apart from the gate electrode, one of the source electrode and the drain electrode is described as the first electrode and the other one of the source electrode and the drain electrode is described as the second electrode.

In addition, transistors can be divided into N-type and P-type transistors according to their characteristics. In the case where a transistor is a P-type transistor, a turn-on voltage is a low-level voltage (for example, 0V, −5V, −10V or other suitable voltages), and a turn-off voltage is a high-level voltage (for example, 5V, 10V or other suitable voltages); in the case where a transistor is an N-type transistor, a turn-on voltage is a high-level voltage (for example, 5V, 10V or other suitable voltages), and a turn-off voltage is a low-level voltage (for example, 0V, −5V, −10V or other suitable voltages). However, the embodiments of the present disclosure do not limit the type of the transistors, in the case where the types of the transistors change, the connection relationship in the circuit can be adjusted accordingly.

A working principle of the pixel circuit 101 as illustrated in FIG. 2A will be described below with reference to the signal timing diagram as illustrated in FIG. 3. As illustrated in FIG. 3, a display process of each frame of image includes three stages, which are respectively a reset stage 1, a data writing and compensation stage 2, and a light-emitting stage 3.

It should be noted that FIG. 2A is a schematic diagram of the pixel circuit 101 in the reset stage; FIG. 2B is a schematic diagram of the pixel circuit 101 as illustrated in FIG. 2A when it is in the data writing and compensation stage; FIG. 2C is a schematic diagram of the pixel circuit 101 as illustrated in FIG. 2A when it is in the light-emitting stage. In addition, the transistors marked with dotted lines in FIG. 2B and FIG. 2C all indicate that they are in a turn-off state during the corresponding stage.

For example, in the pixel circuit 101 as illustrated in FIG. 2A, the driving transistor DT, the data writing transistor T1 (the first reset transistor T2), the second reset transistor T3, the first light-emitting control transistor T4, the second light-emitting control transistor T5 and the third reset transistor T6 are all N-type transistors, that is, each transistor is turned on in the case where a high-level signal is applied to its gate electrode, and is turned off in the case where a low-level signal is applied to its gate electrode.

As illustrated in FIG. 2B and FIG. 3, the embodiments of the present disclosure provide a driving method, the driving method includes: in the data writing and compensation stage, making the data scan signal G1 a turn-on signal to turn on the data writing transistor T1, and writing the data signal DATA into the second terminal 100b of the driving circuit 100 (the second electrode of the driving transistor DT) through the data writing transistor T1 and the first compensation capacitor Cst1. For the pixel circuit 101, in the case where the data writing transistor T1 is turned on, the data signal DATA is firstly applied to the first electrode of the first compensation capacitor Cst1, so that a voltage of the second electrode of the driving transistor DT changes by a voltage variation of the second electrode of the first compensation capacitor Cst1, thereby causing the voltage of the second electrode of the driving transistor DT to reach a specific value. For example, when entering the light-emitting stage 3 from the data writing and compensation stage 2, the data writing transistor T1 changes from the turn-on state to the turn-off state, because a parasitic capacitor exists between the gate electrode of the data writing transistor T1 and the first electrode of the data writing transistor T1, and under a voltage-dividing effect of the parasitic capacitor and the first compensation capacitor Cst1, a voltage variation of the first electrode of the first compensation capacitor Cst1 can be small, so that the voltage variation of the second electrode of the first compensation capacitor Cst1 can be small, which can reduce an impact of the data writing transistor T1 on the voltage of the second electrode of the driving transistor DT in the case where the data writing transistor T1 is turned off, which is beneficial to maintaining a stability of the driving current flowing through the driving transistor DT to improve the brightness uniformity of the display panel.

Specifically, for example, as illustrated in FIG. 1 and FIG. 3, in the reset stage 1, the driving method includes: making the first reset control signal RST1 a turn-on signal to turn on the first reset circuit 300, so that the first reset circuit 300 applies the reference signal REF to the first electrode of the first compensation capacitor Cst1; and, making the first light-emitting control signal EM1 a turn-on signal to turn on the first light-emitting control circuit 600, so that the first light-emitting control circuit 600 applies the second power supply voltage ELVDD to the first terminal 100a of the driving circuit 100; making the third reset control signal RST3 a turn-on signal to turn on the third light-emitting control circuit 800, so that the third reset control signal RST3 applies the second power supply voltage ELVDD to the control terminal 100m of the driving circuit 100; making the second light-emitting control signal EM2 a turn-on signal to turn on the second light-emitting control circuit 700; and making the second reset control signal RST2 a turn-on signal to turn on the second reset circuit 500, so that the second reset circuit 500 applies the first reset signal VINI1 to the first electrode 400a of the light-emitting element 400, the first reset signal VINI1 is applied to the second terminal 100b of the driving circuit 100 through the second light-emitting control circuit 700, and a value of the first reset signal VINI1 is Vini1. Thus, an initial voltage value of the second terminal 100b of the driving circuit 100 before entering the data writing and compensation stage is Vini1.

Correspondingly, for example, as illustrated in FIG. 2A and FIG. 3, in the reset stage 1, in the pixel circuit 101, because the data writing transistor T1 is multiplexed as the first reset transistor T2, the data scan signal G1 is multiplexed as the first reset control signal RST1, so that by making the data scan signal G1 a high-level signal to turn on the data writing transistor T1, the reference signal REF can be applied to the first electrode of the data writing transistor T1, and then applied to the first electrode of the first compensation capacitor Cst1. Moreover, the first light-emitting control signal EM1 is a high-level signal to turn on the first light-emitting control transistor T4, and the third reset control signal RST3 is a high-level signal to turn on the third reset transistor T6, so that the second power supply voltage ELVDD can be applied to the first electrode of the driving transistor DT, and to the gate electrode of the driving transistor DT through the third reset transistor T6. At the same time, the second light-emitting control signal EM2 is a high-level signal to turn on the second light-emitting control transistor T5, and the second reset control signal RST2 is a high-level signal to turn on the second reset transistor T3, then the first reset signal VINI1 may be applied to the first electrode (fourth node N4) of the light-emitting element OLED, and applied to the second electrode (third node N3) of the driving transistor DT through the second light-emitting control transistor T5, so that a voltage value of the second electrode of the driving transistor DT and a voltage value of the first electrode of the light-emitting element OLED are both equal to the value Vini1 of the first reset signal VINI1.

For example, as illustrated in FIG. 1 and FIG. 3, the driving method further includes: in the data writing and compensation stage 2, making the data scan signal G1 a turn-on signal to turn on the data writing transistor T1, and writing the data signal DATA into the second terminal 100b of the driving circuit 100 (that is, the second electrode of the driving transistor DT) through the data writing transistor T1 and the first compensation capacitor Cst1, and making the second reset control signal RST2 a turn-on signal to turn on the second reset circuit 500, so that the second reset circuit 500 applies the first reset signal VINI1 to the first electrode 400a of the light-emitting element 400 and the second electrode of the compensation control capacitor Ca.

Specifically, as illustrated in FIG. 2B and FIG. 3, in the data writing and compensation stage 2, the second reset control signal RST2 is a high-level signal to turn on the second reset transistor T3, so that the first reset signal VINI1 can be applied to the first electrode (fourth node N4) of the light-emitting element OLED and the second electrode of the compensation control capacitor Ca, and the voltage value of the first electrode (fourth node N4) of the light-emitting element OLED is equal to the value Vini1 of the first reset signal VINI1, which can prevent the light-emitting element OLED from emitting light in the data writing and compensation stage 2. At the same time, the data scan signal G1 is a high-level signal to turn on the data writing transistor T1, so that the data signal DATA is applied to the first electrode of the first compensation capacitor Cst1.

For example, as illustrated in FIG. 2B and FIG. 3, in the data writing and compensation stage 2, a difference between an initial voltage value Vc11 of the first electrode of the first compensation capacitor Cst1 before entering the data writing and compensation stage and its stable voltage value Vc12 in the data writing and compensation stage is a first variation ΔVc1, a difference between an initial voltage value Vc13 of the second electrode of the first compensation capacitor Cst1 before entering the data writing and compensation stage and its stable voltage value Vc14 in the data writing and compensation stage is a second variation ΔVc2, the first variation ΔVc1 is equal to the second variation ΔVc2.

For example, as illustrated in FIG. 2B and FIG. 3, the initial voltage value Vc11 of the first electrode of the first compensation capacitor Cst1 before entering the data writing and compensation stage is a value Vref of the reference signal REF, the stable voltage value Vc12 of the first electrode of the first compensation capacitor Cst1 in the data writing and compensation stage is a value Vdata of the data signal DATA, therefore, the first variation ΔVc1=Vdata−Vref. The initial voltage value Vc13 of the second electrode of the first compensation capacitor Cst1 before entering the data writing and compensation stage is the value Vini1 of the first reset signal VINI1, according to a characteristic that the voltage between the first electrode and the second electrode of the first compensation capacitor Cst1 cannot change suddenly, therefore, a voltage of the second electrode of the first compensation capacitor Cst1 will correspondingly have the first variation ΔVc1, that is, the second variation ΔVc2 is equal to the first variation ΔVc1. Therefore, a voltage variation of the second terminal of the driving transistor DT is equal to the first variation ΔVc1. The initial voltage value of the second terminal of the driving transistor DT before entering the data writing and compensation stage is the value Vini1 of the first reset signal VINI1, therefore, a stable voltage value of the second terminal of the driving transistor DT in the data writing and compensation stage is Vini1+ΔVc1 (ΔVc2), which is equal to Vini1+Vdata−Vref.

For example, as illustrated in FIG. 2B and FIG. 3, before entering the data writing and compensation stage, an initial voltage of the gate electrode of the driving transistor DT is the second power supply voltage ELVDD, and a difference (Vgs) between the second power supply voltage ELVDD and the value Vini1 of the first reset signal VINI1 is greater than a threshold voltage Vth of the driving transistor DT, that is, Vgs=ELVDD−Vini1>Vth, therefore, the driving transistor DT is in a turn-on state, and the second electrode of the driving transistor DT is charged through the first electrode of the driving transistor DT until the driving transistor DT is turned off (closed), so that the gate-source voltage Vgs of the driving transistor DT is equal to Vth, at this time, the voltage value of the gate electrode of the driving transistor DT (the voltage value of the first electrode of the compensation control capacitor Ca) is Vini1+Vdata−Vref+Vth, therefore, this charging process can make information such as the threshold voltage Vth of the driving transistor DT be stored in the compensation control capacitor Ca, thereby completing the data writing and compensation process.

For example, as illustrated in FIG. 1 and FIG. 3, in the light-emitting stage 3, the first light-emitting control signal EM1 is a turn-on signal to turn on the first light-emitting control circuit 600, and the first light-emitting control circuit 600 applies the second power supply voltage ELVDD to the first terminal 100a of the driving circuit 100; the second light-emitting control signal EM2 is a turn-on signal to turn on the second light-emitting control circuit 700, and the second light-emitting control circuit 700 applies the driving current to the first electrode 400a of the light-emitting element 400 to drive it to emit light.

Correspondingly, as illustrated in FIG. 2C and FIG. 3, in the light-emitting stage 3, the first light-emitting control signal EM1 is a high-level signal to turn on the first light-emitting control transistor T4, and the second power supply voltage ELVDD is applied to the first electrode of the driving transistor DT. At the same time, the second light-emitting control signal EM2 is a high-level signal to turn on the second light-emitting control transistor T5, and the driving current is applied to the light-emitting element OLED through the second light-emitting control transistor T5 to drive it to emit light.

For example, as illustrated in FIG. 2C and FIG. 3, in the light-emitting stage 3, because the light-emitting element OLED is in a light-emitting state, the voltage value of the first electrode of the light-emitting element OLED (the voltage value of the fourth node N4) and the voltage value of the second electrode of the driving transistor DT all correspond to a voltage value Voled in the case where the light-emitting element OLED emits light, therefore, a variation ΔV of the voltage value of the first electrode of the light-emitting element OLED is Voled−Vini1. Correspondingly, the compensation control capacitor Ca can exert a bootstrap function, so that the voltage value of the first electrode of the compensation control capacitor Ca has the variation ΔV, thereby making that the voltage value of the gate electrode of the driving transistor DT (the voltage value of the second node N2) has the variation ΔV, so that the voltage value of the gate electrode of the driving transistor DT is Vini1+Vdata−Vref+Vth+ΔV, which is equal to Vini1+Vdata−Vref+Vth+Voled−Vini1. The driving transistor DT is in the turn-on state, and the gate-source voltage Vgs of the driving transistor DT is Vini1+Vdata−Vref+Vth+Voled−Vini1−Voled, which is equal to Vdata−Vref+Vth.

A value I of the driving current flowing through the light-emitting element can be obtained according to the following formula: I=K×(Vgs−Vth)², K is a conductivity coefficient of the driving transistor DT, that is: I=K×(Vdata−Vref)².

According to the above formula, it can be seen that the value I of the driving current flowing through the light-emitting element is no longer related to the threshold voltage Vth of the driving transistor DT, therefore, a compensation for the pixel circuit can be realized, and a problem of the shift of the threshold voltage Vth of the driving transistor DT caused by a manufacturing process and long-term operation can be solved, and an impact of the threshold voltage Vth on the driving current can be eliminated, thereby improving the display effect of the display device adopting this pixel circuit.

For example, as illustrated in FIG. 2B, FIG. 2C and FIG. 3, when entering into the light-emitting stage 3 from the data writing and compensation stage 2, the data writing transistor T1 is switched from the turn-on state to the turn-off state, during this process, because a parasitic capacitor existing between the gate electrode of the data writing transistor T1 and the first electrode of the data writing transistor T1, and the parasitic capacitor is connected in series with the first compensation capacitor Cst1, therefore, in the case where the voltage of the gate electrode of the data writing transistor T1 decreases, the parasitic capacitor existing between the gate electrode of the data writing transistor T1 and the first electrode of the data writing transistor T1 and the first compensation capacitor Cst1 can perform a voltage-dividing effect, so that a variation of the voltage value of the first electrode of the first compensation capacitor Cst1 is small. For example, a voltage value of the parasitic capacitor between the gate electrode of the data writing transistor T1 and the first electrode of the data writing transistor T1 may be C0, and a voltage value of the first compensation capacitor Cst1 may be C1, therefore, in the case where a voltage value of the gate electrode of the data writing transistor T1 decreases by ΔV1, a variation of the voltage value of the first compensation capacitor Cst1 is ΔV1×C0/(C0+C1). Because the voltage value C0 of the parasitic capacitor between the gate electrode of the data writing transistor T1 and the first electrode of the data writing transistor T1 is usually much smaller than the voltage value C1 of the first compensation capacitor Cst1, so that a variation of the voltage value of the first compensation capacitor Cst1 will be correspondingly small. Therefore, by making that the first electrode of the data writing transistor T1 is electrically connected to the first electrode of the first compensation capacitor Cst1, and the second electrode of the first compensation capacitor Cst1 is electrically connected to the second electrode of the driving transistor DT, an impact of the data writing transistor T1 on the voltage of the second electrode of the driving transistor DT when the data writing transistor T1 is switched from the turn-on state to the turn-off state can be reduced, which makes the variation of the voltage value of the second electrode of the driving transistor DT is small. In this way, a difference between the voltage of the gate electrode of the driving transistor DT and the voltage of the second electrode of the driving transistor DT (that is, the gate-source voltage Vgs of the driving transistor DT) is basically unchanged, or has a small fluctuation, so as to facilitate to make the driving current flowing through the light-emitting element more stable and make the brightness of the display panel more uniform.

In the pixel circuit provided by the embodiment of the present application, by combining the data writing transistor T1 with other components such as the first compensation capacitor Cst1, the technical problem on compensating the threshold voltage Vth of the driving transistor DT can be solved, which eliminates the impact of the threshold voltage Vth on the driving current. At the same time, when entering the light-emitting stage from the data writing and compensation stage and the data writing transistor T1 being turned off, the impact of the data writing transistor T1 on the gate-source voltage Vgs of the driving transistor DT is small, thereby making the driving current more stable and improving the display effect of the display panel.

For example, as illustrated in FIG. 2A, the capacitance value C1 of the first compensation capacitor Cst1 may be 30 times to 100 times the capacitance value C0 of the parasitic capacitor between the gate electrode of the data writing transistor T1 and the first electrode of the data writing transistor T1. For example, it can be at least one of 30 times to 50 times, 40 times to 80 times, 50 times to 70 times, and 60 times to 90 times, but the embodiments of the present disclosure are not limited thereto. With this arrangement, in the case where the voltage value of the gate electrode of the data writing transistor T1 decreases by ΔV1, the variation ΔV1×C0/(C0+C1) of the voltage value of the first compensation capacitor Cst1 is small, thereby reducing the impact of the data writing transistor T1 on the gate-source voltage Vgs of the driving transistor DT when the data writing transistor T1 is turned off.

For example, as illustrated in FIG. 2A, the capacitance value C1 of the first compensation capacitor Cst1 can be 100 fF to 300 fF, for example, it can be at least one of 100 fF to 150 fF, 120 fF to 180 fF, 200 fF to 250 fF, 230 fF to 250 fF and 240 fF to 280 fF, but the embodiments of the present disclosure are not limited thereto. For example, the capacitance value C0 of the parasitic capacitor between the gate electrode of the data writing transistor T1 and the first electrode of the data writing transistor T1 may be 3 fF to 5 fF, such as 3 fF, 3.5 fF, 4 fF, and 4.5 fF, but the embodiments of the present disclosure are not limited thereto.

FIG. 4 is a schematic block diagram of another pixel circuit provided by at least one embodiment of the present disclosure.

For example, as illustrated in FIG. 4, the pixel circuit 20 includes a driving circuit 100, a data writing circuit 200 (a first reset circuit 300), a light-emitting element 400, a second reset circuit 500, a first light-emitting control circuit 600, and a second light-emitting control circuit 700, a third reset circuit 800 and a compensation control circuit 900. Compared with the pixel circuit 10 as illustrated in FIG. 1, a difference of the pixel circuit 20 is that a control terminal 200m of the data writing circuit 200 is electrically connected with a control terminal 500m of the second reset circuit 500. For example, a data scan signal G1 and a second reset control signal RST2 can be the same control signal to simultaneously control the data writing circuit 200 and the second reset circuit 500 to be turned on or turned off, thereby simplifying the structure of the pixel circuit. For other structures in the pixel circuit 20, please refer to the relevant descriptions of FIG. 1 in the above embodiments, which will not be repeated here.

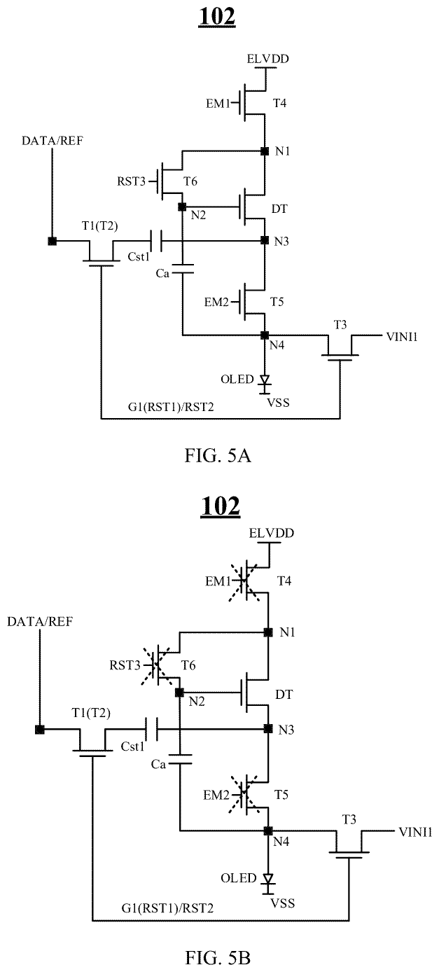

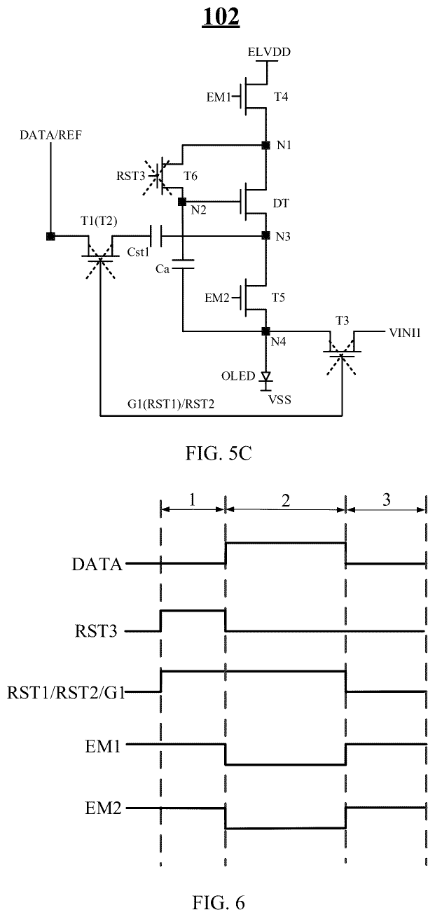

FIG. 5A is a circuit diagram of an implementation example of the pixel circuit as illustrated in FIG. 4; FIG. 6 is a signal timing diagram of another driving method provided by at least one embodiment of the present disclosure. It should be noted that FIG. 5A is a schematic diagram in the case where a pixel circuit 102 is in a reset stage; FIG. 5B is a schematic diagram of the pixel circuit 102 as illustrated in FIG. 5A when it is in a data writing and compensation stage; FIG. 5C is a schematic diagram of the pixel circuit 102 as illustrated in FIG. 5A when it is in a light-emitting stage. In addition, the transistors marked with dotted lines in FIG. 5B and FIG. 5C all indicate that they are in a turn-off state during the corresponding stage.

For example, the pixel circuit as illustrated in FIG. 4 can be implemented as a pixel circuit structure as illustrated in FIG. 5A.

For example, as illustrated in FIG. 5A, the pixel circuit 102 includes a driving transistor DT, a data writing transistor T1 (a first reset transistor T2), a second reset transistor T3, a first light-emitting control transistor T4, a second light-emitting control transistor T5, and a third reset transistor T6, a first compensation capacitor Cst1, a compensation control capacitor Ca and a light-emitting element OLED. For example, a difference between the pixel circuit 102 and the pixel circuit 101 (as illustrated in FIG. 2A) is that the gate electrode of the data writing transistor T1 is electrically connected with the gate electrode of the second reset transistor T3, and the data writing transistor T1 and the second reset transistor T3 shares a gate electrode, the data scan signal G1 serves as the second reset control signal RST2, and the type of the data writing transistor T1 is the same as that of the second reset transistor T3.

For example, as illustrated in FIG. 5A, a corresponding timing diagram of the pixel circuit 102 can refer to FIG. 6. For example, during a driving process of the pixel circuit 102, a working state (for example, the turn-on state or the turn-off state) of each transistor is the same as that of the pixel circuit 101 as illustrated in FIG. 2A. Compared with the timing diagram as illustrated in FIG. 3, timing states of the data signal DATA, the first reset control signal RST1, the second reset control signal RST2, the third reset control signal RST3, the data scan signal G1, the first light-emitting control signal EM1 and the second light-emitting control signal EM2 in the timing diagram in FIG. 6 remain the same, the difference being that the data scan signal G1 is multiplexed as the second reset control signal RST2.

For example, as illustrated in FIG. 5A and FIG. 6, both the data writing transistor T1 and the second reset transistor T3 are N-type transistors. For example, in the reset stage 1, the data scan signal G1 is a high-level signal, the data writing transistor T1 serves as the second reset transistor T2, and the data scan signal G1 can serve as the first reset control signal RST1 to turn on the second reset transistor T2, so that the reference signal REF can be applied to the first electrode of data writing transistor T1. At the same time, the data scan signal G1 further serves as the second reset control signal RST2, so that the second reset transistor T3 is turned on, and the first reset signal VINI1 is applied to the first electrode of the light-emitting element OLED.

For example, as illustrated in FIG. 5B and FIG. 6, in the data writing and compensation stage 2, the data scan signal G1 is a high-level signal, and the data writing transistor T1 is turned on in response to the data scan signal G1, so that the data signal DATA can be applied to the first electrode of the first compensation capacitor Cst1. At the same time, the data scan signal G1 further serves as the second reset control signal RST2, so that the second reset transistor T3 is turned on, and the first reset signal VINI1 is applied to the first electrode of the light-emitting element OLED.

For example, as illustrated in FIG. 5C and FIG. 6, in the light-emitting stage 3, the data scan signal G1 is a low-level signal, and both the data writing transistor T1 and the second reset transistor T3 are turned off in response to the data scan signal G1. For the working process and corresponding technical effects of the pixel circuit 102 as illustrated in FIG. 5A in the reset stage 1, the data writing and compensation stage 2, and the light-emitting stage 3, please refer to the relevant descriptions of FIG. 2A to FIG. 2C in the above embodiments, which will not be repeated.

For example, as illustrated in FIG. 5A, by making that the data writing transistor T1 and the second reset transistor T3 in the pixel circuit 102 share a gate electrode, the turn-on state and turn-off state of the data writing transistor T1 and the second reset transistor T3 can be simultaneously controlled by the same control signal (that is, the data scan signal G1), thereby simplifying the structure of the pixel circuit 102 and making the control method of the pixel circuit 102 simpler.

For example, referring to FIG. 5A, the gate electrode of the data writing transistor T1 and the gate electrode of the second reset transistor T3 may be independent of each other and not electrically connected. For example, as illustrated in FIG. 2A, the data scan signal G1 and the second reset control signal RST2 can be different signals, for example, they can be from different signal output terminals to control the turn-on state and the turn-off state of the data writing transistor T1 and the second reset transistor T3, respectively. For example, in some embodiments of the present disclosure, the gate electrode of the data writing transistor T1 and the gate electrode of the reset control signal RST2 may be independent of each other, and the data scan signal G1 and the second reset control signal RST2 may be both connected to the same signal output terminal, and the data scan signal G1 is applied to the gate electrode of the data writing transistor T1, and the second reset control signal RST2 is applied to the gate electrode of the second reset transistor T3, the embodiments of the present disclosure do not limit whether the gate electrode of the data writing transistor T1 is electrically connected with the gate electrode of the reset control signal RST2, which can be flexibly adjusted according to the design requirements.

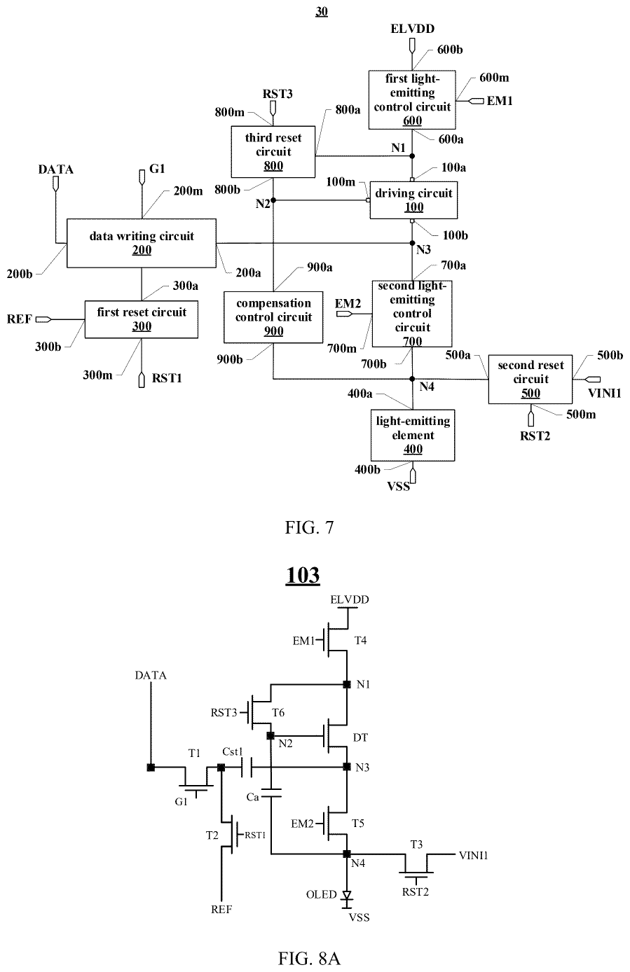

FIG. 7 is a schematic block diagram of another pixel circuit provided by at least one embodiment of the present disclosure.

For example, as illustrated in FIG. 7, the pixel circuit 30 includes a driving circuit 100, a data writing circuit 200, a first reset circuit 300, a light-emitting element 400, a second reset circuit 500, a first light-emitting control circuit 600, a second light-emitting control circuit 700, a third reset circuit 800 and a compensation control circuit 900. Compared with the pixel circuit 10 as illustrated in FIG. 1, a difference of the pixel circuit 30 is that the control terminal 200m of the data writing circuit 200 and the control terminal 300m of the first reset circuit 300 are independent of each other. The control terminal 200m of the data writing circuit 200 is configured to receive the data scan signal G1, and the control terminal 300m of the first reset circuit 300 is configured to receive the first reset control signal RST1, the data scan signal G1 and the first reset control signal RST1 can be different signals, and they can come from different signal terminals.

For other structures in the pixel circuit 30, please refer to the relevant descriptions of FIG. 1 in the above embodiments, which will not be repeated here.

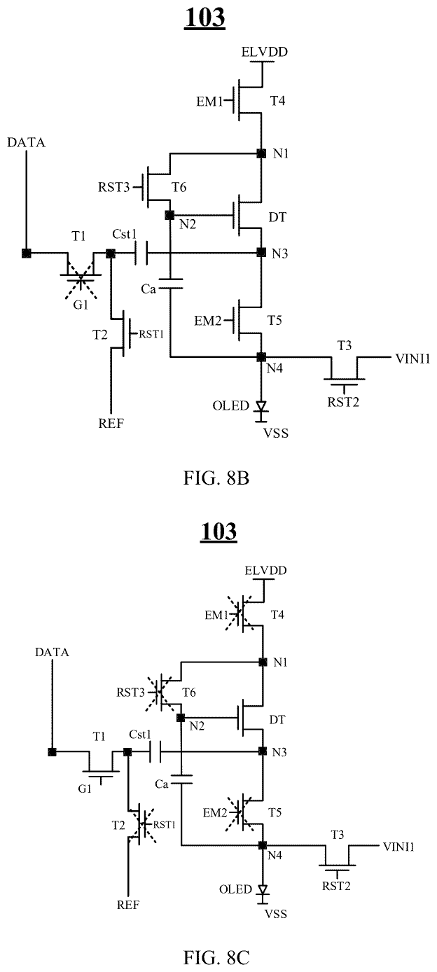

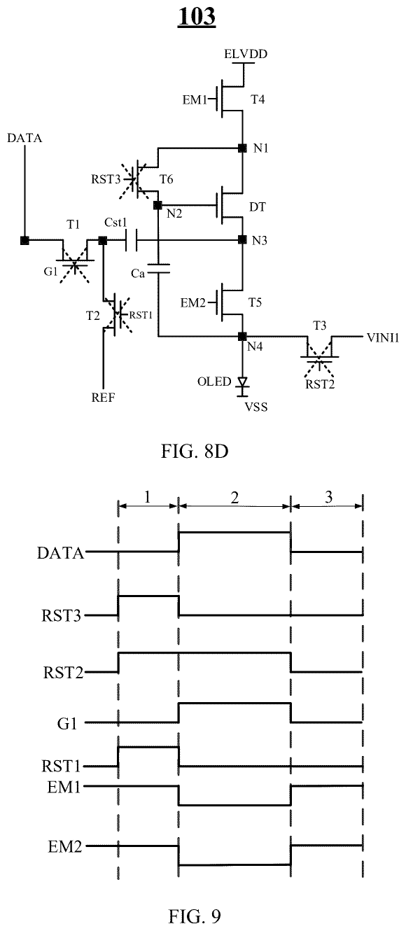

FIG. 8A is a circuit diagram of an implementation example of the pixel circuit as illustrated in FIG. 7; FIG. 9 is a signal timing diagram of another driving method provided by at least one embodiment of the present disclosure. It should be noted that FIG. 8B is a schematic diagram of the pixel circuit 103 as illustrated in FIG. 8A when it is in a reset stage; FIG. 8C is a schematic diagram of the pixel circuit 103 as illustrated in FIG. 8A when it is in a data writing and compensation stage; FIG. 8D is a schematic diagram of the pixel circuit 103 as illustrated in FIG. 8A when it is in a light-emitting stage. In addition, the transistors marked with dotted lines in FIG. 8B to FIG. 8D all indicate that they are in a turn-off state during the corresponding stage.

For example, the pixel circuit as illustrated in FIG. 7 can be implemented as a pixel circuit structure as illustrated in FIG. 8A.

For example, as illustrated in FIG. 8A, the pixel circuit 103 includes a driving transistor DT, a data writing transistor T1, a first reset transistor T2, a second reset transistor T3, a first light-emitting control transistor T4, a second light-emitting control transistor T5, a third reset transistor T6, a first compensation capacitor Cst1, a compensation control capacitor Ca and a light-emitting element OLED. For example, a difference between the pixel circuit 103 and the pixel circuit 101 (as illustrated in FIG. 2A) is that the data writing transistor T1 and the first reset transistor T2 are independently controlled transistors, the gate electrode of the data writing transistor T1 is electrically connected with the data control terminal G1, the gate electrode of the first reset transistor T2 is electrically connected with the first reset control terminal RST1, and the data control terminal G1 and the first reset control terminal RST1 are different signal terminals independent of each other, the data signal terminal DATA and the reference signal terminal REF are different signal terminals independent of each other. With this arrangement, the data writing transistor T1 and the first reset transistor T2 can be controlled independently, so that the pixel circuit 103 has a more flexible control method.

For example, the timing diagram corresponding to the pixel circuit 103 can refer to FIG. 9. For example, as illustrated in FIG. 8A and FIG. 9, during a driving process of the pixel circuit 103, a difference between the working state of each transistor in the pixel circuit 103 and the working state of each transistor of the pixel circuit 101 as illustrated in FIG. 2A is that the working state of the data writing transistor T1 is different from the working state of the first reset transistor T2. For example, compared with the timing diagram as illustrated in FIG. 3, timing states of the data signal DATA, the second reset control signal RST2, the third reset control signal RST3, the first light-emitting control signal EM1 and the second light-emitting control signal EM2 remain the same, the difference being that a timing state of the data scan signal G1 is different from a timing state of the first reset control signal RST1.

For example, as illustrated in FIG. 8B and FIG. 9, in the reset stage 1, the data scan signal G1 is a low-level signal, so that the data writing transistor T1 is in a turn-off state. The first reset control signal RST1 is a high-level signal, so that the first reset transistor T2 is in a turn-on state, and the reference signal REF is applied to the first electrode of the first compensation capacitor Cst1 through the first reset transistor T2.

For example, as illustrated in FIG. 8C and FIG. 9, in the data writing and compensation stage 2, the data scan signal G1 is a high-level signal, so that the data writing transistor T1 is in a turn-on state, and the data signal DATA is applied to the first electrode of the first compensation capacitor Cst1 through the data writing transistor T1, and then written to the second electrode of the driving transistor DT. The first reset control signal RST1 is a low-level signal, so that the first reset transistor T2 is in a turn-off state.

For example, as illustrated in FIG. 8D and FIG. 9, in the light-emitting stage 3, the data scan signal G1 and the first reset control signal RST1 are both low-level signals, so that the data writing transistor T1 and the first reset transistor T2 are both in the turn-off state. For the working process and corresponding technical effects of the pixel circuit 103 as illustrated in FIG. 8A in the reset stage 1, the data writing and compensation stage 2, and the light-emitting stage 3, please refer to the relevant descriptions of FIG. 2A to FIG. 2C in the above embodiments, which will not be repeated.

For example, as illustrated in FIG. 8A, by making the data writing transistor T1 and the first reset transistor T2 be independently controlled transistors, the control method of the pixel circuit 103 can be more flexible to be adapted to different design requirements.

For example, referring to FIG. 8A, in some embodiments of the present disclosure, in the case where the data writing transistor T1 and the first reset transistor T2 are independently controlled transistors, and the data control terminal G1 and the first reset control terminal RST1 are different signal terminals that are independent of each other, and the data signal terminal DATA and the reference signal terminal REF are different signal terminals that are independent of each other, and a type of the data writing transistor T1 may be different from a type of the first reset transistor T2. For example, the data writing transistor T1 may be an N-type transistor, and the first reset transistor T2 may be a P-type transistor; or, the data writing transistor T1 may be a P-type transistor, and the first reset transistor T2 may be an N-type transistor, as long as the data writing transistor T1 and the first reset transistor T2 are in specific states in different control stages, that is: the data writing transistor T1 is in the turn-off state in the reset stage 1 and the light-emitting stage 3, and is in the turn-on state in the data writing and compensation stage 2; the first reset transistor T2 is in the turn-on state in the reset stage 1, and is in the turn-off state in the data writing and compensation stage 2 and the light-emitting stage 3, which can be adapted to more flexible design requirements.

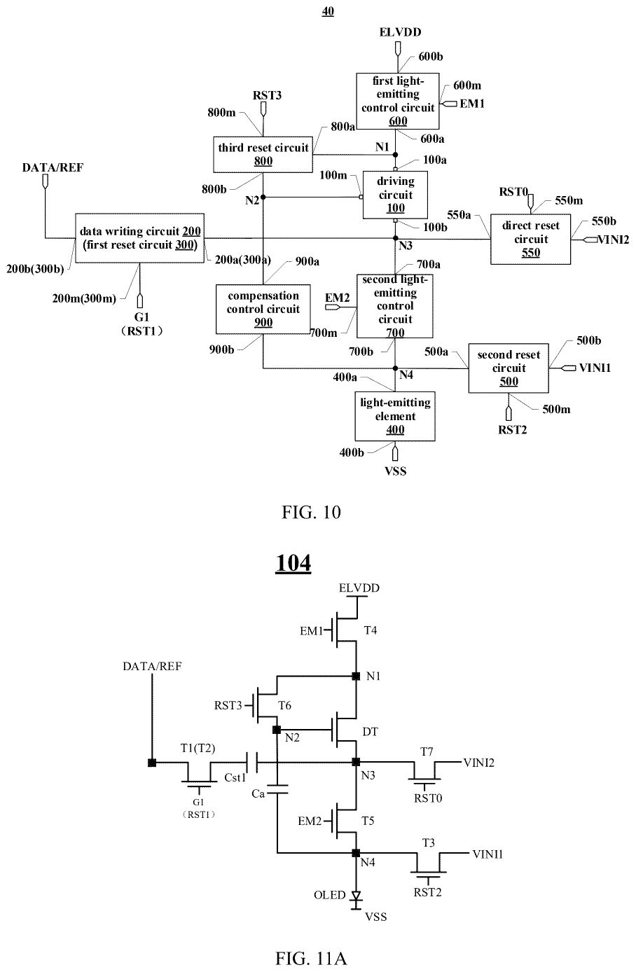

FIG. 10 is a schematic block diagram of another pixel circuit provided by at least one embodiment of the present disclosure.

For example, as illustrated in FIG. 10, a pixel circuit 40 includes a driving circuit 100, a data writing circuit 200 (a first reset circuit 300), a light-emitting element 400, a second reset circuit 500, a first light-emitting control circuit 600, and a second light-emitting control circuit 700, a third reset circuit 800, a compensation control circuit 900 and a direct reset circuit 550. Compared with the pixel circuit 10 as illustrated in FIG. 1, a difference of the pixel circuit 40 is that the direct reset circuit 550 is added, for other structures in the pixel circuit 40, please refer to the relevant descriptions of FIG. 1 in the above embodiment, which will not be repeat here.

For example, as illustrated in FIG. 10, a control terminal 550m of the direct reset circuit 550 is configured to receive a direct reset control signal RST0, a first terminal 550a of the direct reset circuit 550 is electrically connected with the second terminal 100b of the driving circuit 100, a second terminal 550b of the direct reset circuit 550 is electrically connected with a second reset signal terminal VINI2 to receive a second reset signal VINI2, the direct reset circuit 550 is configured to directly apply the second reset signal VINI2 to the second terminal 100b of the driving circuit 100 in response to the direct reset control signal RST0. For example, in the case where the direct reset control signal RST0 is a turn-on signal, the direct reset circuit 550 is turned on in response to the direct reset control signal RST0, thereby allowing the second reset signal VINI2 to be directly applied to the second terminal 100b of the driving circuit 100. The direction application of the second reset signal VINI2 to the second terminal 100b of the driving circuit 100 means that no other components such as a transistor and a capacitor are provided between the direct reset circuit 550 and the driving circuit 100, so that the second reset signal VINI2 can be applied to the second terminal 100b of the driving circuit 100 without passing through any other components such as the transistor and the capacitor other than the direct reset circuit 550. With this arrangement, the direct reset circuit 550 can perform a more accurate and faster reset operation on the second terminal 100b of the driving circuit 100, so that the voltage of the second terminal 100b of the driving circuit 100 is more accurate in the reset stage.

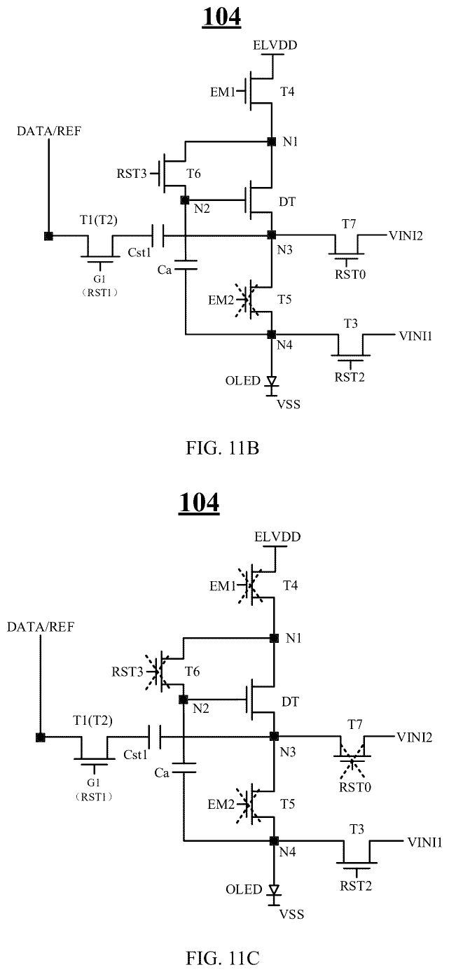

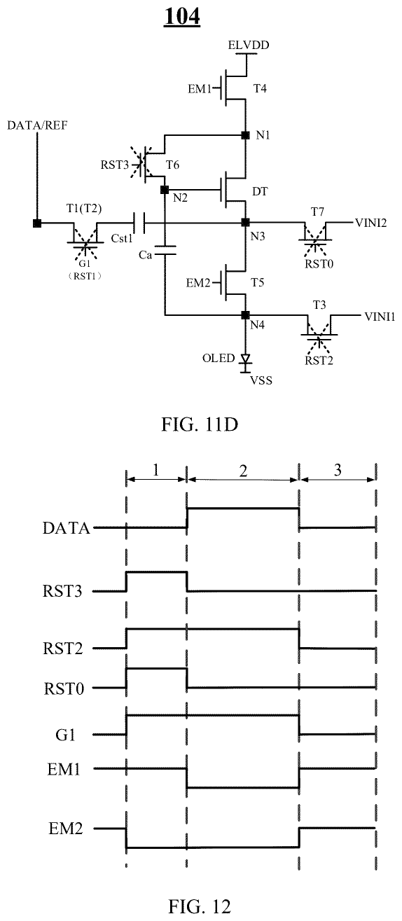

FIG. 11A is a circuit diagram of an implementation example of the pixel circuit as illustrated in FIG. 10; FIG. 12 is a signal timing diagram of another driving method provided by at least one embodiment of the present disclosure. It should be noted that FIG. 11B is a schematic diagram of a pixel circuit 104 as illustrated in FIG. 11A when it is in a reset stage; FIG. 11C is a schematic diagram of the pixel circuit 104 as illustrated in FIG. 11A when it is in a data writing and compensation stage; FIG. 11D is a schematic diagram of the pixel circuit 104 as illustrated in FIG. 11A when it is in a light-emitting stage. In addition, the transistors marked with dotted lines in FIG. 11B to FIG. 11D all indicate that they are in a turn-off state during the corresponding stage.

For example, the pixel circuit as illustrated in FIG. 10 can be implemented as a pixel circuit structure as illustrated in FIG. 11A.

For example, as illustrated in FIG. 11A, the pixel circuit 104 includes a driving transistor DT, a data writing transistor T1 (a first reset transistor T2), a second reset transistor T3, a first light-emitting control transistor T4, a second light-emitting control transistor T5, a third reset transistor T6, a direct reset transistor T7, a first compensation capacitor Cst1, a compensation control capacitor Ca and a light-emitting element OLED. For example, a difference between the pixel circuit 104 and the pixel circuit 101 (as illustrated in FIG. 2A) is that the direct reset transistor T7 is added.

For example, as illustrated in FIG. 11A, the direct reset circuit 550 includes the direct reset transistor T7, a gate electrode of the direct reset transistor T7 is electrically connected with the direct reset control signal terminal RST0 to receive the direct reset control signal RST0, a first electrode of the direct reset transistor T7 is electrically connected with the second terminal 100b of the driving circuit 100, and a second electrode of the direct reset transistor T7 is electrically connected with the second reset signal terminal VINI2 to receive the second reset signal VINI2. For example, no other components such as a transistor and a capacitor are provided between the second electrode of the driving transistor DT and the direct reset transistor T7, so that the second reset signal VINI2 can be directly applied to the second electrode of the driving transistor DT in the case where the direct reset transistor T7 is turned on.

For example, a timing diagram corresponding to the pixel circuit 104 can refer to FIG. 12. For example, as illustrated in FIG. 11A and FIG. 12, a difference between the pixel circuit 104 and the pixel circuit 101 as illustrated in FIG. 2A is that the direct reset transistor T7 is added, and working states of the other transistors in different control stages (for example, the turn-on state or the turn-off state) are the same. For example, compared with the timing diagram as illustrated in FIG. 3, timing states of the data signal DATA, the second reset control signal RST2, the third reset control signal RST3, the first light-emitting control signal EM1, the second light-emitting control signal EM2, and the data scan signal G1 in the timing diagram in FIG. 12 remain the same, a difference being that a timing state corresponding to the direct reset control signal RST0 is added.

For example, as illustrated in FIG. 11B and FIG. 12, in the reset stage 1, in the pixel circuit 104, because the data writing transistor T1 is multiplexed as the first reset transistor T2, the data scan signal G1 is multiplexed as the first reset control signal RST1, so that by making the data scan signal G1 a high-level signal to turn on the data writing transistor T1, the reference signal REF can be applied to the first electrode of the data writing transistor T1, and then applied to the first electrode of the first compensation capacitor Cst1. Moreover, the first light-emitting control signal EM1 is a high-level signal to turn on the first light-emitting control transistor T4, and the third reset control signal RST3 is a high-level signal to turn on the third reset transistor T6, so that the second power supply voltage ELVDD can be applied to the first electrode of the driving transistor DT, and to the gate electrode of the driving transistor DT through the third reset transistor T6. At the same time, the second light-emitting control signal EM2 is a low-level signal to turn off the second light-emitting control transistor T5, and the second reset control signal RST2 is a high-level signal to turn on the second reset transistor T3, so that the first reset signal VINI1 can be applied to the first electrode (the fourth node N4) of the light-emitting element OLED, and a voltage value of the first electrode of the light-emitting element OLED is equal to the value Vini1 of the first reset signal VINI1.

For example, as illustrated in FIG. 10 and FIG. 11B, in the reset stage 1, the driving method further includes: making the direct reset control signal RST0 a turn-on signal to turn on the direct reset circuit 550, so that the second reset signal VINI2 can be applied to the second terminal 100b of the driving circuit 100. A value of the second reset signal VINI2 is Vini2, so that an initial voltage value of the second terminal 100b of the driving circuit 100 before entering the data writing and compensation stage is Vini2. Specifically, for example, as illustrated in FIG. 11B and FIG. 12, the direct reset control signal RST0 is a high-level signal to turn on the direct reset transistor T7, so that the second reset signal VINI2 is applied to the second electrode of the driving transistor DT, to reset the voltage of the second electrode of the driving transistor DT, and a voltage value of the second electrode of the driving transistor DT is the value Vini2 of the second reset signal VINI2.

For example, as illustrated in FIG. 11C and FIG. 12, in the data writing and compensation stage 2, the second reset control signal RST2 is a high-level signal to turn on the second reset transistor T3, so that the first reset signal VINI1 can be applied to the first electrode (the fourth node N4) of the light-emitting element OLED and the second electrode of the compensation control capacitor Ca, and a voltage value of the first electrode of the light-emitting element OLED is the value Vini1 of the first reset signal VINI1, thereby avoiding the light-emitting element OLED to emit light in the data writing and compensation stage 2. At the same time, the data scan signal G1 is a high-level signal to turn on the data writing transistor T1, so that the data signal DATA can be applied to the first electrode of the first compensation capacitor Cst1.

For example, as illustrated in FIG. 11C and FIG. 12, in the data writing and compensation stage 2, a difference between an initial voltage value Vc11 of the first electrode of the first compensation capacitor Cst1 before entering the data writing and compensation stage and its stable voltage value Vc12 in the data writing and compensation stage is a first variation ΔVc1, a difference between an initial voltage value Vc13 of the second electrode of the first compensation capacitor Cst1 before entering the data writing and compensation stage and its stable voltage value Vc14 in the data writing and compensation stage is a second variation ΔVc2, the first variation ΔVc1 is equal to the second variation ΔVc2.

For example, as illustrated in FIG. 11C and FIG. 12, the initial voltage value Vc11 of the first electrode of the first compensation capacitor Cst1 before entering the data writing and compensation stage is a value Vref of the reference signal REF, the stable voltage value Vc12 of the first electrode of the first compensation capacitor Cst1 in the data writing and compensation stage is a value Vdata of the data signal DATA, therefore, the first variation ΔVc1=Vdata−Vref. The initial voltage value Vc13 of the second electrode of the first compensation capacitor Cst1 before entering the data writing and compensation stage is the value Vini2 of the second reset signal VINI2. According to the characteristic that the voltage between the first electrode and the second electrode of the first compensation capacitor Cst1 cannot change suddenly, a voltage of the second electrode of the first compensation capacitor Cst1 will correspondingly have the first variation ΔVc1, that is, the second variation ΔVc2 is equal to the first variation ΔVc1. Therefore, a voltage variation of the second terminal of the driving transistor DT is equal to the first variation ΔVc1. The initial voltage value of the second terminal of the driving transistor DT before entering the data writing and compensation stage is the value Vini2 of the second reset signal VINI2, therefore, a stable voltage value of the second terminal of the driving transistor DT in the data writing and compensation stage is Vini2+ΔVc1 (ΔVc2), which is equal to Vini2+Vdata−Vref.

For example, as illustrated in FIG. 11C and FIG. 12, before entering the data writing and compensation stage, an initial voltage of the gate electrode of the driving transistor DT is the second power supply voltage ELVDD, and a difference (Vgs) between the second power supply voltage ELVDD and the value Vini2 of the second reset signal VINI2 is greater than a threshold voltage Vth of the driving transistor DT, that is, Vgs=ELVDD−Vini2>Vth, therefore, the driving transistor DT is in a turn-on state, and the second electrode of the driving transistor DT is charged through the first electrode of the driving transistor DT until the driving transistor DT is turned off (closed), so that the gate-source voltage Vgs of the driving transistor DT is equal to Vth, at this time, the voltage value of the gate electrode of the driving transistor DT (the voltage value of the first electrode of the compensation control capacitor Ca) is Vini2+Vdata−Vref+Vth, therefore, this charging process can make information such as the threshold voltage Vth of the driving transistor DT be stored in the compensation control capacitor Ca, thereby completing the data writing and compensation process.

For example, as illustrated in FIG. 11D and FIG. 12, in the light-emitting stage 3, the first light-emitting control signal EM1 is a high-level signal to turn on the first light-emitting control transistor T4, and the second power supply voltage ELVDD is applied to the first electrode of the driving transistor DT. At the same time, the second light-emitting control signal EM2 is a high-level signal to turn on the second light-emitting control transistor T5, and the driving current is applied to the light-emitting element OLED through the second light-emitting control transistor T5 to drive it to emit light.

For example, as illustrated in FIG. 11D and FIG. 12, in the light-emitting stage 3, because the light-emitting element OLED is in a light-emitting state, the voltage value of the first electrode of the light-emitting element OLED (the voltage value of the fourth node N4) and the voltage value of the second electrode of the driving transistor DT all correspond to a voltage value Voled in the case where the light-emitting element OLED emits light, therefore, a variation ΔV of the voltage value of the first electrode of the light-emitting element OLED is Voled−Vini1. Correspondingly, the compensation control capacitor Ca can exert a bootstrap function, so that the voltage value of the first electrode of the compensation control capacitor Ca has the variation ΔV, thereby making that the voltage value of the gate electrode of the driving transistor DT (the voltage value of the second node N2) has the variation ΔV. Thus, the voltage value of the gate electrode of the driving transistor DT is Vini2+Vdata−Vref+Vth+ΔV, which is equal to Vini2+Vdata−Vref+Vth+Voled−Vini1. The driving transistor DT is in the turn-on state, and the gate-source voltage Vgs of the driving transistor DT is Vini2+Vdata−Vref+Vth+Voled−Vini1−Voled, which is equal to (Vini2−Vini1)+Vdata−Vref+Vth.

A value I of the driving current flowing through the light-emitting element can be obtained according to the following formula: I=K×(Vgs−Vth)², K is a conductivity coefficient of the driving transistor DT, that is: I=K×(Vini2−Vini1+Vdata−Vref)².

For example, as illustrated in FIG. 11D, the value Vini1 of the first reset signal VINI1 may be equal to the value Vini2 of the second reset signal VINI2, so that the value I of the driving current of the light-emitting element OLED in the light-emitting stage is K×(Vdata−Vref)², but the embodiments of the present disclosure are not limited to this. For example, in some embodiments, the value Vini1 of the first reset signal VINI1 may not be equal to the value Vini2 of the second reset signal VINI2, which is not limited in the embodiments of the present disclosure.

According to the above formula, it can be seen that the value I of the driving current flowing through the light-emitting element is no longer related to the threshold voltage Vth of the driving transistor DT, therefore, the compensation for the pixel circuit can be realized, and the problem of the shift of the threshold voltage Vth of the driving transistor DT caused by the manufacturing process and long-term operation can be solved, and the impact of the threshold voltage Vth on the driving current can be eliminated, thereby improving the display effect of the display device adopting this pixel circuit.

For example, as illustrated in FIG. 11C, FIG. 11D and FIG. 12, in the data writing and compensation stage 2 and the light-emitting stage 3, the direct reset control signal RST0 is a low-level signal, and the direct reset transistor T7 is turned off in responding to the direct reset control signal RST0. For the working process and corresponding technical effects of the pixel circuit 104 as illustrated in FIG. 11A in the reset stage 1, the data writing and compensation stage 2, and the light-emitting stage 3, please refer to the relevant descriptions of FIG. 2A to FIG. 2C in the above embodiments, which will not be repeated.

Of course, the embodiments of the present disclosure do not limit the type of the direct reset transistor T7, for example, the direct reset transistor T7 can be a P-type transistor, that is, in the case where the direct reset control signal RST0 is a low-level signal, the direct reset transistor T7 is turned on; and in the case where the direct reset control signal RST0 is a high-level signal, the direct reset transistor T7 is turned off, which can be specifically set according to the design requirements.

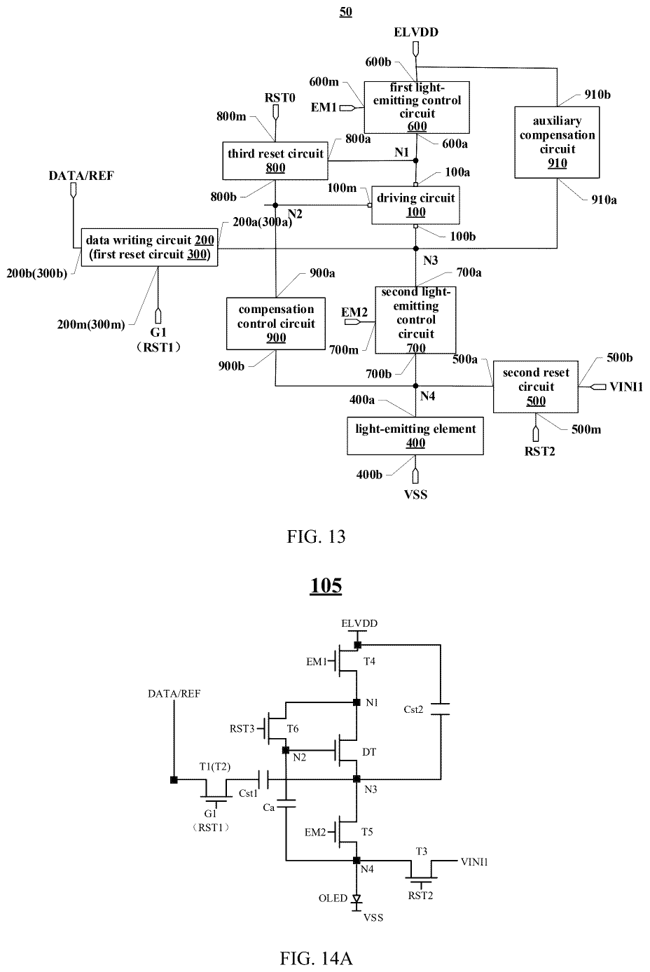

FIG. 13 is a schematic block diagram of another pixel circuit provided by at least one embodiment of the present disclosure.

For example, as illustrated in FIG. 13, the pixel circuit 50 includes a driving circuit 100, a data writing circuit 200 (a first reset circuit 300), a light-emitting element 400, a second reset circuit 500, a first light-emitting control circuit 600, and a second light-emitting control circuit 700, a third reset circuit 800, a compensation control circuit 900 and an auxiliary compensation circuit 910. Compared with the pixel circuit 10 as illustrated in FIG. 1, a difference of the pixel circuit 50 is that the auxiliary compensation circuit 910 is added, a first terminal 910a of the auxiliary compensation circuit 910 is electrically connected with the second terminal 100b of the driving circuit 100, a second terminal 910b of the auxiliary compensation circuit 910 is electrically connected with the second voltage terminal ELVDD. For other structures in the pixel circuit 50, please refer to the relevant descriptions of FIG. 1 in the above embodiments, which will not be repeated here.

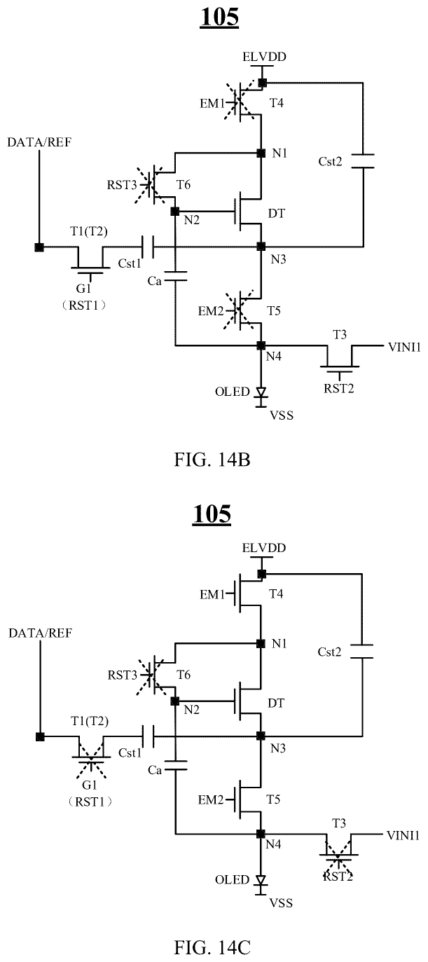

FIG. 14A is a circuit diagram of an implementation example of the pixel circuit as illustrated in FIG. 13, and FIG. 14A is a schematic diagram of the pixel circuit 105 as illustrated in FIG. 13 when it is in a reset stage; FIG. 14B is a schematic diagram of the pixel circuit 105 as illustrated in FIG. 13 when it is in a data writing and compensation stage; FIG. 14C is a schematic diagram of the pixel circuit 105 as illustrated in FIG. 13 when it is in a light-emitting stage. In addition, the transistors marked with dotted lines in FIG. 14B to FIG. 14C all indicate that they are in a turn-off state during the corresponding stage.

For example, the pixel circuit as illustrated in FIG. 13 can be implemented as a pixel circuit structure as illustrated in FIG. 14A.

For example, as illustrated in FIG. 13 and FIG. 14A, the pixel circuit 105 includes a driving transistor DT, a data writing transistor T1 (a first reset transistor T2), a second reset transistor T3, a first light-emitting control transistor T4, a second light-emitting control transistor T5, a third reset transistor T6, a first compensation capacitor Cst1, a compensation control capacitor Ca, a second compensation capacitor Cst2 and a light-emitting element OLED. For example, a difference between the pixel circuit 105 and the pixel circuit 101 (as illustrated in FIG. 2A) is that the second compensation capacitor Cst2 is added.

For example, as illustrated in FIG. 13 and FIG. 14A, the auxiliary compensation circuit 910 includes the second compensation capacitor Cst2, and a first electrode of the second compensation capacitor Cst2 is electrically connected with the second terminal 100b of the driving circuit 100, a second electrode of the second compensation capacitor Cst2 is configured to receive a first constant signal. For example, in the pixel circuit 105 as illustrated in FIG. 14A, the second terminal of the second compensation capacitor Cst2 is electrically connected with the second voltage terminal ELVDD, and the second power supply voltage ELVDD serves as the first constant signal, but the embodiments of the present disclosure are not limited thereto.

For example, a timing diagram corresponding to the pixel circuit 105 can refer to FIG. 3. For example, as illustrated in FIG. 13 and FIG. 14A, the difference between the pixel circuit 105 and the pixel circuit 101 as illustrated in FIG. 2A is that the second compensation capacitor Cst2 is added, and working states of the other transistors in different control stages (for example, the turn-on state or the turn-off state) are the same.

For example, as illustrated in FIG. 3, FIG. 13 and FIG. 14A, in the reset stage 1, the driving method includes: making the first reset control signal RST1 a turn-on signal to turn on the first reset circuit 300, so that the first reset circuit 300 applies the reference signal REF to the first electrode of the first compensation capacitor Cst1; secondly, making the first light-emitting control signal EM1 a turn-on signal to turn on the first light-emitting control circuit 600, so that the first light-emitting control circuit 600 applies the second power supply voltage ELVDD to the first terminal 100a of the driving circuit 100; making the third reset control signal RST3 a turn-on signal to turn on the third reset circuit 800, so that the third reset circuit 800 applies the second power supply voltage ELVDD to the control terminal 100m of the driving circuit 100; making the second light-emitting control signal EM2 a turn-on signal to turn on the second light-emitting control circuit 700; and making the second reset control signal RST2 a turn-on signal to turn on the second reset circuit 500, so that the second reset circuit 500 applies the first reset signal VINI1 to the first electrode 400a of the light-emitting element 400, and the first reset signal VINI1 is applied to the second terminal 100b of the driving circuit 100 through the second light-emitting control circuit 700, and the value of the first reset signal VINI1 is Vini1, so that the initial voltage value of the second terminal 100b of the driving circuit 100 before entering the data writing and compensation stage 2 is Vini1.

Specifically, for example, as illustrated in FIG. 3, FIG. 13 and FIG. 14A, in the pixel circuit 105, because the data writing transistor T1 is multiplexed as the first reset transistor T2, the data scan signal G1 is multiplexed as the first reset control signal RST1, so that, by making the data scan signal G1 a high-level signal to turn on the data writing transistor T1, the reference signal REF can be applied to the first electrode of the data writing transistor T1, and then be applied to the first electrode of the first compensation capacitor Cst1. Then, by making the first light-emitting control signal EM1 a high-level signal to turn on the first light-emitting control transistor T4, and making the third reset control signal RST3 a high-level signal to turn on the third reset transistor T6, the second power supply voltage ELVDD can be applied to the first electrode of the driving transistor DT and to the gate electrode of the driving transistor DT through the third reset transistor T6. At the same time, by making the second light-emitting control signal EM2 a high-level signal to turn on the second light-emitting control transistor T5, and making the second reset control signal RST2 a high-level signal to turn on the second reset transistor T3, the first reset signal VINI1 can be applied to the first electrode (the fourth node N4) of the light-emitting element OLED, and be applied to the second electrode (the third node N3) of the driving transistor DT through the second light-emitting control transistor T5, so that the voltage value of the second electrode of the driving transistor DT and the voltage value of the first electrode of the light-emitting element OLED are both equal to the value Vini1 of the first reset signal VINI1.

For example, as illustrated in FIG. 3, FIG. 13 and FIG. 14B, in the data writing and compensation stage 2, the driving method includes: making the second reset control signal RST2 a turn-on signal to turn on the second reset circuit 500, and the second reset circuit 500 applies the first reset signal VINI1 to the first electrode 400a of the light-emitting element 400 and the second electrode of the compensation control capacitor Ca.

Specifically, as illustrated in FIG. 3 and FIG. 14B, in the data writing and compensation stage 2, the second reset control signal RST2 is a high-level signal to turn on the second reset control transistor T3, so that the first reset signal VINII can be applied to the first electrode (the fourth node N4) of the light-emitting element OLED and the second electrode of the compensation control capacitor Ca, and the voltage value of the first electrode of the light-emitting element OLED is the value Vini1 of the first reset signal VINI1, thereby preventing the light-emitting element OLED from emitting light in the data writing and compensation stage 2. At the same time, the data scan signal G1 is a high-level signal to turn on the data writing transistor T1, so that the data signal DATA is applied to the first electrode of the first compensation capacitor Cst1.

For example, as illustrated in FIG. 3 and FIG. 14B, in the data writing and compensation stage 2, the first compensation capacitor Cst1 is connected in series with the second compensation capacitor Cst2, and a voltage Vc3 of the second terminal 100b of the driving circuit 100 is equal to (Vdata−Vref)×[C1/(C1+C2)]+Vini1, Vdata represents the value of the data signal DATA, Vref represents the initial voltage value of the first electrode of the first compensation capacitor Cst1 before entering the data writing and compensation stage, and C1 represents the capacitance value of the first compensation capacitor Cst1, C2 represents the capacitance value of the second compensation capacitor Cst2, and Vini1 represents the initial voltage value of the second terminal 100b of the driving circuit 100 before entering the data writing and compensation stage.

For example, as illustrated in FIG. 3 and FIG. 14B, the second electrode of the first compensation capacitor Cst1 is electrically connected with the first electrode of the second compensation capacitor Cst2, and both of the second electrode of the first compensation capacitor Cst1 and the first electrode of the second compensation capacitor Cst2 are electrically connected with the second electrode of the driving transistor DT. Therefore, the first compensation capacitor Cst1 is connected in series with the second compensation capacitor Cst2. The initial voltage value of the first electrode of the first compensation capacitor Cst1 before entering the data writing and compensation stage (that is, in the reset stage 1) is equal to the value Vref of the reference signal REF, a stable voltage value of the first compensation capacitor Cst1 in the data writing and compensation stage is equal to the value Vdata of the data signal DATA. In the case of switching from the data writing and compensation stage to the light emitting stage, the second electrode of the second compensation capacitor Cst2 receives the first constant signal, and a voltage variation of the first electrode of the first compensation capacitor Cst1 is Vdata−Vref, so that a variation of a difference between a voltage of the first electrode of the second compensation capacitor Cst2 and a voltage of the second electrode of the second compensation capacitor Cst2 is (Vdata−Vref)×[C1/(C1+C2)]. Because the voltage value of the second electrode of the second compensation capacitor Cst2 has not changed (equal to the value of the first constant signal), a variation of the voltage of the first electrode of the second compensation capacitor Cst2 is (Vdata−Vref)×[C1/(C1+C2)], that is, a variation of the voltage of the second electrode of the driving transistor DT is (Vdata−Vref)×[C1/(C1+C2)]. Because the initial voltage value of the second electrode of the driving transistor DT before entering the data writing and compensation stage 2 (that is, the voltage value in the reset stage 1) is Vini1, in the data writing and compensation stage 2, the voltage Vc3 of the second electrode of the driving transistor DT is equal to (Vdata−Vref)×[C1/(C1+C2)]+Vini1.

For example, as illustrated in FIG. 3 and FIG. 14B, before entering the data writing and compensation stage, an initial voltage of the gate electrode of the driving transistor DT is the second power supply voltage ELVDD, and a difference (Vgs) between the second power supply voltage ELVDD and the value Vini1 of the first reset signal VINI1 is greater than a threshold voltage Vth of the driving transistor DT, that is, Vgs=ELVDD−Vini1>Vth, therefore, the driving transistor DT is in a turn-on state, and the second electrode of the driving transistor DT is charged through the first electrode of the driving transistor DT until the driving transistor DT is turned off (closed), so that the gate-source voltage Vgs of the driving transistor DT is equal to Vth. At this time, the voltage value of the gate electrode of the driving transistor DT (the voltage value of the first electrode of the compensation control capacitor Ca) is Vc3+Vth=(Vdata−Vref)×[C1/(C1+C2)]+Vini1+Vth, therefore, this charging process can make information such as the threshold voltage Vth of the driving transistor DT be stored in the compensation control capacitor Ca, thereby completing the data writing and compensation process.

For example, as illustrated in FIG. 3, FIG. 13 and FIG. 14C, in the light-emitting stage 3, the first light-emitting control signal EM1 is a turn-on signal to turn on the first light-emitting control circuit 600, and the first light-emitting control circuit 600 applies the second power supply voltage ELVDD to the first terminal 100a of the driving circuit 100; the second light-emitting control signal EM2 is a turn-on signal to turn on the second light-emitting control circuit 700, and the second light-emitting control circuit 700 applies the driving current to the first electrode 400a of the light-emitting element 400 to drive it to emit light.

Correspondingly, as illustrated in FIG. 3 and FIG. 14C, in the light-emitting stage 3, the first light-emitting control signal EM1 is a high-level signal to turn on the first light-emitting control transistor T4, and the second power supply voltage ELVDD is applied to the first electrode of the driving transistor DT. At the same time, the second light-emitting control signal EM2 is a high-level signal to turn on the second light-emitting control transistor T5, and the driving current is applied to the light-emitting element OLED through the second light-emitting control transistor T5 to drive it to emit light.

For example, as illustrated in FIG. 3 and FIG. 14C, in the light-emitting stage 3, because the light-emitting element OLED is in a light-emitting state, the voltage value of the first electrode of the light-emitting element OLED (the voltage value of the fourth node N4) and the voltage value of the second electrode of the driving transistor DT (the voltage value of the third node N3) all correspond to a voltage value Voled in the case where the light-emitting element OLED emits light, therefore, a variation ΔV of the voltage value of the first electrode of the light-emitting element OLED is Voled−Vini1. Correspondingly, the compensation control capacitor Ca can exert a bootstrap function, so that the voltage value of the first electrode of the compensation control capacitor Ca has the variation ΔV, thereby making that the voltage value of the gate electrode of the driving transistor DT (the voltage value of the second node N2) has the variation ΔV. Thus, the voltage value of the gate electrode of the driving transistor DT is Vc3+Vth+ΔV, which is equal to (Vdata−Vref)×[C1/(C1+C2)]+Vini1+Vth+Voled−Vini1, and is equal to (Vdata−Vref)×[C1/(C1+C2)]+Vth+Voled, the driving transistor DT is in the turn-on state, and the gate-source voltage Vgs of the driving transistor DT is (Vdata−Vref)×[C1/(C1+C2)]+Vth+Voled-Voled, which is equal to (Vdata−Vref)×[C1/(C1+C2)]+Vth.

A value I of the driving current flowing through the light-emitting element can be obtained according to the following formula: I=K×(Vgs−Vth)², K is a conductivity coefficient of the driving transistor DT, that is: I=K×{(Vdata−Vref)×[C1/(C1+C2)]}².

According to the above formula, it can be seen that the value I of the driving current flowing through the light-emitting element is no longer related to the threshold voltage Vth of the driving transistor DT, therefore, the compensation for the pixel circuit can be realized, and the problem of the shift of the threshold voltage Vth of the driving transistor DT caused by the manufacturing process and long-term operation can be solved, and the impact of the threshold voltage Vth on the driving current can be eliminated, thereby improving the display effect of the display device adopting this pixel circuit.

For example, as illustrated in FIG. 3, FIG. 14B and FIG. 14C, when entering into the light-emitting stage 3 from the data writing and compensation stage 2, the data writing transistor T1 is switched from the turn-on state to the turn-off state. During this process, because a parasitic capacitor exists between the gate electrode of the data writing transistor T1 and the first electrode of the data writing transistor T1, and the parasitic capacitor is connected in series with the first compensation capacitor Cst1, in the case where the voltage of the gate electrode of the data writing transistor T1 decreases, the parasitic capacitor existing between the gate electrode of the data writing transistor T1 and the first electrode of the data writing transistor T1 and the first compensation capacitor Cst1 can perform a voltage-dividing effect, so that a variation of the voltage value of the first electrode of the first compensation capacitor Cst1 is small. With this arrangement, an impact of the data writing transistor T1 on the voltage of the second electrode of the driving transistor DT when the data writing transistor T1 is switched from the turn-on state to the turn-off state can be reduced, which makes the variation of the voltage value of the second electrode of the driving transistor DT is small. Therefore, the gate-source voltage Vgs of the driving transistor DT is basically unchanged, or has a small fluctuation, so as to facilitate to make the driving current flowing through the light-emitting element more stable. In addition, in the case where parasitic capacitor also exists between a signal line and the second electrode of the driving transistor DT, the second electrode of the driving transistor DT serves as one electrode of the parasitic capacitor, so that the parasitic capacitor is connected in series with the second compensation capacitor Cst2. In the case where a voltage of the other electrode of the parasitic capacitor changes, the parasitic capacitor and the second compensation capacitor Cst2 can perform a voltage-dividing effect, so that the variation of the voltage value of the first electrode of the second compensation capacitor Cst2 is small, which further makes the voltage of the second electrode of the driving transistor DT more stable, so that the brightness of the display panel is more uniform.

For example, as illustrated in FIG. 14A, the capacitance value C2 of the second compensation capacitor Cst2 may be 30 times to 100 times a capacitance value of the parasitic capacitor between the above-mentioned one signal line and the second electrode of the driving transistor DT. For example, it may be at least one of 30 times to 40 times, 45 times to 65 times, 55 times to 75 times, and 60 times to 80 times, but the embodiments of the present disclosure are not limited thereto. For example, the capacitance value C2 of the second compensation capacitor Cst2 may be 100 fF to 300 fF, such as at least one of 120 fF to 150 fF, 140 fF to 180 fF, 210 fF to 240 fF, 230 fF to 250 fF, and 260 fF to 280 fF, but the embodiments of the present disclosure are not limited thereto. For example, the capacitance value of the parasitic capacitor between the above-mentioned one signal line and the second electrode of the driving transistor DT may be 3 fF to 5 fF, such as 3 fF, 3.5 fF, 4 fF, and 4.5 fF, but the embodiments of the present disclosure are not limited thereto. With this arrangement, an impact of a voltage fluctuation of the signal line on the gate-source voltage Vgs of the driving transistor DT can be eliminated, thereby making the driving current of the driving transistor DT more stable.

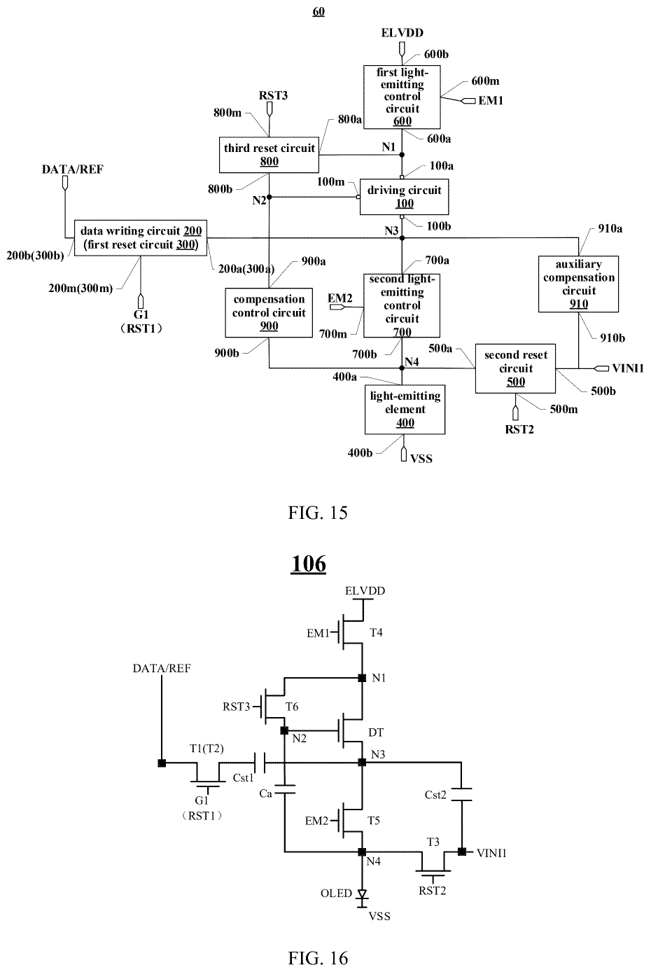

FIG. 15 is a schematic block diagram of another pixel circuit provided by at least one embodiment of the present disclosure.

For example, as illustrated in FIG. 15, the pixel circuit 60 includes a driving circuit 100, a data writing circuit 200 (a first reset circuit 300), a light-emitting element 400, a second reset circuit 500, a first light-emitting control circuit 600, a second light-emitting control circuit 700, a third reset circuit 800, a compensation control circuit 900 and an auxiliary compensation circuit 910. Compared with the pixel circuit 50 as illustrated in FIG. 13, a difference of the pixel circuit 60 is that the auxiliary compensation circuit 910 is connected in a different manner, in the pixel circuit 60, the first terminal 910a of the auxiliary compensation circuit 910 is electrically connected with the second terminal 100b of the driving circuit 100, and the second terminal 910b of the auxiliary compensation circuit 910 is electrically connected with the first reset signal terminal VINI1. For other structures in the pixel circuit 60, please refer to the relevant descriptions of FIG. 13 in the above embodiments, which will not be repeated here.

FIG. 16 is a circuit diagram of an implementation example of the pixel circuit as illustrated in FIG. 15.

For example, the pixel circuit as illustrated in FIG. 15 can be implemented as a pixel circuit structure as illustrated in FIG. 16.

For example, as illustrated in FIG. 15 and FIG. 16, a pixel circuit 106 includes a driving transistor DT, a data writing transistor T1 (a first reset transistor T2), a second reset transistor T3, a first light-emitting control transistor T4, and a second light-emitting control transistor T5, a third reset transistor T6, a first compensation capacitor Cst1, a compensation control capacitor Ca, a second compensation capacitor Cst2 and a light-emitting element OLED. For example, a difference between the pixel circuit 106 and the pixel circuit 105 (as illustrated in FIG. 14A) is that the second compensation capacitor Cst2 is connected in a different manner. At the same time, a driving method of the pixel circuit 106 as illustrated in FIG. 16 is the same as a driving method of the pixel circuit 105 as illustrated in FIG. 14A, specifically, please refer to the relevant descriptions of the above embodiments, which will not be repeated here.

For example, as illustrated in FIG. 15 and FIG. 16, the auxiliary compensation circuit 910 includes a second compensation capacitor Cst2, and a first electrode of the second compensation capacitor Cst2 is electrically connected with the second electrode of the driving transistor DT, a second electrode of the second compensation capacitor Cst2 is configured to receive a first constant signal. For example, in the pixel circuit 106 as illustrated in FIG. 16, the second electrode of the second compensation capacitor Cst2 is electrically connected with the first reset signal terminal VINI1, and the first reset signal VINI1 serves as the first constant signal, thereby making a connection method of the second compensation capacitor Cst2 more flexible to be adapted to different design requirements.

For example, in some embodiments of the present disclosure, referring to FIG. 16, the second electrode of the second compensation capacitor Cst2 may further be electrically connected with an external constant signal terminal outside the pixel circuit to receive the first constant signal from the external constant signal terminal. With this arrangement, the external constant signal terminal can be used as an independent signal input terminal, so that the voltage of the second electrode of the second compensation capacitor Cst2 can be independently controlled to make it more stable.

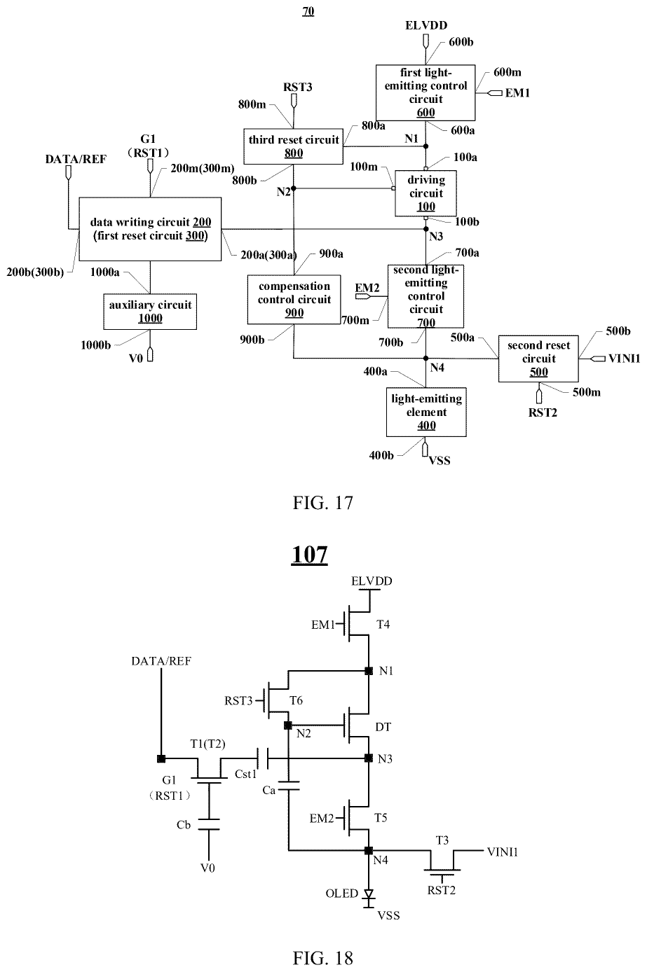

FIG. 17 is a schematic block diagram of another pixel circuit provided by at least one embodiment of the present disclosure.

For example, as illustrated in FIG. 17, the pixel circuit 60 includes a driving circuit 100, a data writing circuit 200 (a first reset circuit 300), a light-emitting element 400, a second reset circuit 500, a first light-emitting control circuit 600, a second light-emitting control circuit 700, a third reset circuit 800, a compensation control circuit 900 and an auxiliary circuit 1000. Compared with the pixel circuit 10 as illustrated in FIG. 1, a difference of the pixel circuit 70 is that the auxiliary circuit 1000 is added. For example, as illustrated in FIG. 17, a first terminal 1000a of the auxiliary circuit 1000 is electrically connected with the data writing circuit 200, a second terminal 1000b of the auxiliary circuit 1000 is configured to receive the second constant signal V0. For other structures in the pixel circuit 70, please refer to the relevant descriptions of FIG. 1 in the above embodiments, which will not be repeated here.

FIG. 18 is a circuit diagram of an implementation example of the pixel circuit as illustrated in FIG. 17.

For example, the pixel circuit as illustrated in FIG. 17 can be implemented as a pixel circuit structure as illustrated in FIG. 18.

For example, as illustrated in FIG. 17 and FIG. 18, a pixel circuit 107 includes a driving transistor DT, a data writing transistor T1 (a first reset transistor T2), a second reset transistor T3, a first light-emitting control transistor T4, a second light-emitting control transistor T5, a third reset transistor T6, a first compensation capacitor Cst1, a compensation control capacitor Ca, an auxiliary capacitor Cb and a light-emitting element OLED. For example, a difference between the pixel circuit 107 and the pixel circuit 101 (as illustrated in FIG. 2A) is that the auxiliary capacitor Cb is added. At the same time, a driving method of the pixel circuit 107 as illustrated in FIG. 18 is the same as the driving method of the pixel circuit 101 as illustrated in FIG. 2A, specifically, please refer to the relevant descriptions of the above embodiments, which will not be repeated here.

For example, as illustrated in FIG. 17 and FIG. 18, the auxiliary circuit 1000 includes the auxiliary capacitor Cb, and a first electrode of the auxiliary capacitor Cb is electrically connected with the gate electrode of the data writing transistor T1, and a second electrode of the auxiliary capacitor Cb is configured to receive a second constant signal V0. For example, in some embodiments of the present disclosure, the second electrode of the auxiliary capacitor Cb may be electrically connected with the second voltage terminal ELVDD, and the second power supply voltage ELVDD serves as the second constant signal V0. For example, the second electrode of the auxiliary capacitor Cb may be electrically connected with the first reset signal terminal VINI1, and the first reset signal VINI1 serves as the second constant signal V0. For example, the second electrode of the auxiliary capacitor Cb can be electrically connected with an external constant signal terminal outside the pixel circuit to receive the second constant signal V0 from the external constant signal terminal, which can be specifically set according to design requirements, the embodiments of the present disclosure does not limit a type of the second constant signal.

For example, as illustrated in FIG. 18, a parasitic capacitor exists between the gate electrode of the data writing transistor T1 and the first electrode of the data writing transistor T1, and the parasitic capacitor is connected in series with the auxiliary capacitor Cb. When the data writing transistor T1 is switched from the turn-on state to the turn-off state, an arrangement of the auxiliary capacitor Cb can slow down a change speed of the voltage of the gate electrode of the data writing transistor T1, so that a decreasing speed of the voltage of the gate electrode of the data writing transistor T1 is reduced, thereby making a voltage fluctuation of the first electrode of the first compensation capacitor Cst1 is smaller, which in turn can reduce the voltage fluctuation of the gate electrode of the driving transistor DT, and make the gate-source voltage Vgs of the driving transistor DT more stable. Thus, the display effect of the display panel is improved.

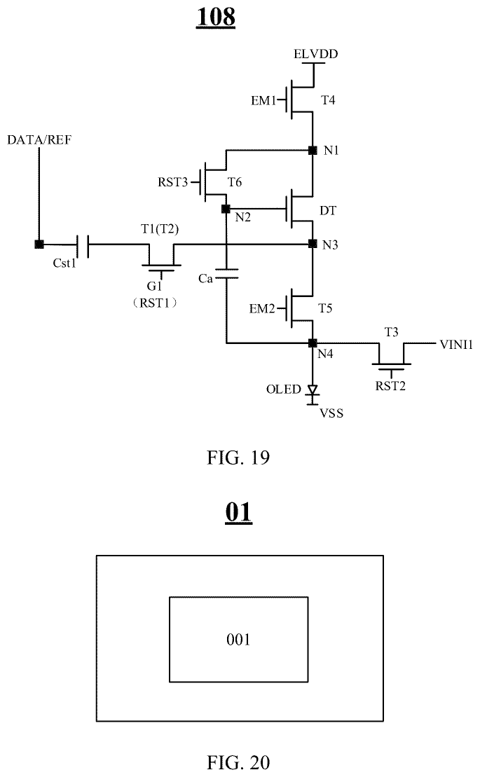

FIG. 19 is a circuit diagram of another implementation example of the pixel circuit as illustrated in FIG. 1.

For example, the pixel circuit as illustrated in FIG. 1 can further be implemented as a pixel circuit structure as illustrated in FIG. 19.

For example, as illustrated in FIG. 19, the pixel circuit 108 includes a driving transistor DT, a data writing transistor T1 (a first reset transistor T2), a second reset transistor T3, a first light-emitting control transistor T4, a second light-emitting control transistor T5, a third reset transistor T6, a first compensation capacitor Cst1, a compensation control capacitor Ca and a light-emitting element OLED. For example, a difference between the pixel circuit 108 and the pixel circuit 101 in FIG. 2A is that the first compensation capacitor Cst1 and the data writing transistor T1 are connected in different ways, and other structures can refer to the relevant descriptions of FIG. 2A in the above embodiments, which will not be repeated here.

For example, as illustrated in FIG. 1 and FIG. 19, a first electrode of the first compensation capacitor Cst1 is electrically connected with the first electrode of the data writing transistor T1, and a second electrode of the first compensation capacitor Cst1 is electrically connected with the data signal terminal DATA to receive the data signal DATA, the second electrode of the data writing transistor T1 is electrically connected with the second terminal 100b of the driving circuit 100 (the second electrode of the driving transistor DT). A timing diagram corresponding to the pixel circuit 108 can refer to FIG. 3, for a working process of the pixel circuit 108, please refer to the relevant descriptions of FIG. 2A to FIG. 2C in the above embodiments, which will not be repeated here.

For example, as illustrated in FIG. 19, on the one hand, by combining the data writing transistor T1 with other components such as the first compensation capacitor Cst1, the technical problem of how to compensate the threshold voltage Vth of the driving transistor DT is solved, which eliminates the impact of the threshold voltage Vth on the driving current of the driving transistor DT. On the other hand, because a parasitic capacitor exists between the gate electrode of the data writing transistor T1 and the first electrode of the data writing transistor T1, and one electrode of the parasitic capacitor is electrically connected with the first electrode of the first compensation capacitor Cst1, so that the parasitic capacitor is connected in series with the first compensation capacitor Cst1. For example, in the case where the data signal DATA or the reference signal REF received by the second electrode of the first compensation capacitor Cst1 undergoes an undesirable fluctuation, the parasitic capacitor between the gate electrode of the data writing transistor T1 and the first electrode of the data writing transistor T1 may perform a voltage-dividing function with the first compensation capacitor Cst1, thereby making a voltage variation of the first electrode of the data writing transistor T1 is small, thereby reducing the voltage fluctuation of the gate electrode of the driving transistor DT, and making the gate-source voltage Vgs of the driving transistor DT more stable, which is facilitate to improve the display effect of the display panel.

FIG. 20 is a schematic block diagram of a display device provided by at least one embodiment of the present disclosure. As illustrated in FIG. 20, a display device 01 includes any pixel circuit provided by the embodiments of the present disclosure. For example, a pixel circuit 001 may be any pixel circuit provided by embodiments of the present disclosure. The display device 01 may be, for example, a device with a display function such as an organic light-emitting diode display device or a quantum dot light-emitting diode display device, or other types of devices, which is not limited by the embodiments of the present disclosure.

Other structures and functions of the display device 01 provided by the embodiment of the present disclosure can be implemented by referring to conventional technologies, which will not be limited by the embodiments of the present disclosure. For the technical effects of the display device 01 provided by the embodiments of the present disclosure, reference can be made to the above descriptions of the technical effects of the pixel circuits provided by the embodiments of the present disclosure, which will not be repeated here.

For example, the display device 01 provided by at least one embodiment of the present disclosure can be any product or component with a display function, such as a display panel, a mobile phone, a tablet computer, a television, a monitor, a notebook computer, a digital photo frame, a navigator or the like, which is not be limited by the embodiments of the present disclosure.

There are the following points to be clarified:
(1) The accompanying drawings of the embodiments of the present disclosure relate only to the structures involved with the embodiments of the present disclosure, and other structures can be referred to the usual design.
(2) Features in the same embodiment and different embodiments of the present disclosure may be combined with each other without conflict.

The foregoing is only an exemplary embodiment of the present disclosure and is not intended to limit the scope of protection of the present disclosure, which is determined by the claims.

1. A pixel circuit, comprising:
a driving circuit, comprising a control terminal, a first terminal and a second terminal, and configured to control a magnitude of a driving current flowing through the first terminal and the second terminal; and
a data writing circuit, comprising a first terminal and a second terminal, wherein the first terminal of the data writing circuit is electrically connected with the second terminal of the driving circuit, and the second terminal of the data writing circuit is configured to receive a data signal, the data writing circuit is configured to write the data signal to the second terminal of the driving circuit in response to a data scan signal, and comprises a data writing transistor and a first compensation capacitor, a gate electrode of the data writing transistor is configured to receive the data scan signal, and a first electrode of the first compensation capacitor is electrically connected with a first electrode of the data writing transistor.

2. The pixel circuit according to claim 1, wherein a second electrode of the first compensation capacitor is electrically connected with the second terminal of the driving circuit, and a second electrode of the data writing transistor is electrically connected with a data signal terminal to receive the data signal.

3. The pixel circuit according to claim 2, wherein a capacitance value of the first compensation capacitor is 30 times to 100 times a capacitance value of a parasitic capacitor between the gate electrode of the data writing transistor and the first electrode of the data writing transistor.

4. The pixel circuit according to claim 2, wherein the capacitance value of the first compensation capacitor is 100 fF to 300 fF.

5. The pixel circuit according to claim 1, wherein a second electrode of the first compensation capacitor is electrically connected with a data signal terminal to receive the data signal, and a second electrode of the data writing transistor is electrically connected with the second terminal of the driving circuit.

6. The pixel circuit according to claim 2, further comprising:
a first reset circuit, wherein a control terminal of the first reset circuit is configured to receive a first reset control signal, a first terminal of the first reset circuit is electrically connected with the first electrode of the first compensation capacitor, a second terminal of the first reset circuit is electrically connected with a reference signal terminal to receive a reference signal, the first reset circuit is configured to write the reference signal to the second terminal of the driving circuit with the first compensation capacitor in response to the first reset control signal.

7. The pixel circuit according to claim 6, wherein the first reset circuit comprises a first reset transistor, a gate electrode of the first reset transistor is electrically connected with a first reset control terminal to receive the first reset control signal, a first electrode of the first reset transistor is electrically connected with the first electrode of the first compensation capacitor, and a second electrode of the first reset transistor is electrically connected with the reference signal terminal to receive the reference signal;
the data writing transistor is multiplexed as the first reset transistor, and the data scan signal is multiplexed as the first reset control signal,
the second electrode of the data writing transistor is further electrically connected with the reference signal terminal to receive the reference signal, and is configured to apply the reference signal to the second terminal of the driving circuit with the first compensation capacitor.

8. (canceled)

9. The pixel circuit according to claim 6, wherein the first reset circuit comprises a first reset transistor, a gate electrode of the first reset transistor is electrically connected with a first reset control terminal to receive the first reset control signal, a first electrode of the first reset transistor is electrically connected with the first electrode of the first compensation capacitor, and a second electrode of the first reset transistor is electrically connected with the reference signal terminal to receive the reference signal;
the data writing transistor and the first reset transistor are independently controlled transistors, respectively, the gate electrode of the data writing transistor is electrically connected with a data control terminal, the gate electrode of the first reset transistor is electrically connected with the first reset control terminal, the data control terminal and the first reset control terminal are different signal terminals that are independent of each other, and the data signal terminal and the reference signal terminal are different signal terminals that are independent of each other.

10. The pixel circuit according to claim 1, further comprising:
a light-emitting element, configured to emit light driven by the driving current, wherein the second terminal of the driving circuit is electrically connected with a first electrode of the light-emitting element, and the driving circuit is configured to control a magnitude of a driving current flowing through the light-emitting element, a second electrode of the light-emitting element is electrically connected with a first voltage terminal to receive a first power supply voltage;
a second reset circuit, wherein a control terminal of the second reset circuit is configured to receive a second reset control signal, a first terminal of the second reset circuit is electrically connected with the first electrode of the light-emitting element, and a second terminal of the second reset circuit is electrically connected with a first reset signal terminal to receive a first reset signal, and the second reset circuit is configured to apply the first reset signal to the first electrode of the light-emitting element in response to the second reset control signal.

11. The pixel circuit according to claim 10, wherein
the second reset circuit comprises a second reset transistor, a gate electrode of the second reset transistor is electrically connected with a second reset control terminal to receive the second reset control signal, and a first electrode of the second reset transistor is electrically connected with the first electrode of the light-emitting element, and a second electrode of the second reset transistor is electrically connected with the first reset signal terminal to receive the first reset signal;
the gate electrode of the data writing transistor is electrically connected with the gate electrode of the second reset transistor, the data writing transistor and the second reset transistor share a gate electrode, and the data scan signal serves as the second reset control signal, a type of the data transistor is the same as a type of the second reset transistor; or, the gate electrode of the data transistor and the gate electrode of the second reset transistor are independent of each other and not electrically connected.

12. The pixel circuit according to claim 10, further comprising:
a first light-emitting control circuit, wherein a control terminal of the first light-emitting control circuit is configured to receive a first light-emitting control signal, and a first terminal of the first light-emitting control circuit is electrically connected with the first terminal of the driving circuit, a second terminal of the first light-emitting control circuit is electrically connected with a second voltage terminal to receive a second power supply voltage, and the first light-emitting control circuit is configured to apply the second power supply voltage to the first terminal of the driving circuit in respond to the first light-emitting control signal; and
a second light-emitting control circuit, wherein a control terminal of the second light-emitting control circuit is configured to receive a second light-emitting control signal, the second light-emitting control signal is different from the first light-emitting control signal, and a first terminal of the second light-emitting control circuit is electrically connected with the second terminal of the driving circuit, a second terminal of the second light-emitting control circuit is electrically connected with the first electrode of the light-emitting element, and the second light-emitting control circuit is configured to apply the driving current to the light-emitting element in response to the second light-emitting control signal.

13. The pixel circuit according to claim 10, further comprising:
a direct reset circuit, a control terminal of the direct reset circuit is configured to receive a direct reset control signal, a first terminal of the direct reset circuit is electrically connected with the second terminal of the driving circuit, a second terminal of the direct reset circuit is electrically connected with a second reset signal terminal to receive a second reset signal, the direct reset circuit is configured to apply the second reset signal directly to the second terminal of the driving circuit in response to the direct reset control signal;
the direct reset circuit comprises a direct reset transistor, a gate electrode of the direct reset transistor is electrically connected with a direct reset control signal terminal to receive the direct reset control signal, and a first electrode of the direct reset transistor is electrically connected with the second terminal of the driving circuit, a second terminal of the direct reset transistor is electrically connected with the second reset signal terminal to receive the second reset signal.

14-15. (canceled)

16. The pixel circuit according to claim 10, further comprising:
an auxiliary compensation circuit, comprising a second compensation capacitor, wherein a first electrode of the second compensation capacitor is electrically connected with the second terminal of the driving circuit, and a second electrode of the second compensation capacitor is configured to receive a first constant signal.

17. (canceled)

18. The pixel circuit according to claim 1, further comprising:
an auxiliary circuit, comprising an auxiliary capacitor, wherein a first electrode of the auxiliary capacitor is electrically connected with the gate electrode of the data writing transistor, and a second electrode of the auxiliary capacitor is configured to receive a second constant signal.

19. The pixel circuit according to claim 12, further comprising:
a third reset circuit, wherein a control terminal of the third reset circuit is configured to receive a third reset control signal, a first terminal of the third reset circuit is electrically connected with the first terminal of the driving circuit, and a second terminal of the third reset circuit is electrically connected with the control terminal of the driving circuit, the third reset circuit is configured to allow the second power supply voltage to be applied to the control terminal of the driving circuit in response to the third reset control signal; and
a compensation control circuit, comprising a compensation control capacitor, wherein a first electrode of the compensation control capacitor is electrically connected with the control terminal of the driving circuit, and a second electrode of the compensation control capacitor is electrically connected with the first electrode of the light-emitting element.

20. (canceled)

21. A display device, comprising the pixel circuit according to claim 1.

22. A driving method of a pixel circuit, suitable for the pixel circuit according to claim 1, the driving method comprising:
in a data writing and compensation stage, making the data scan signal a turn-on signal to turn on the data writing transistor, and writing the data signal into the second terminal of the driving circuit through the data writing transistor and the first compensation capacitor.

23. The driving method according to claim 22, wherein a control terminal of the data writing circuit is configured to receive a data scan signal, and the second terminal of the data writing circuit is electrically connected with a data signal terminal to receive the data signal;
in the case of entering a light-emitting stage from the data writing and compensation stage, changing the data scan signal from the turn-on signal to a turn-off signal to turn off the data writing transistor, wherein in the light-emitting stage, the data scan signal remains as the turn-off signal.

24. The driving method according to claim 22, wherein during writing the data signal into the second terminal of the driving circuit through the data writing transistor and the first compensation capacitor,
a difference between an initial voltage value Vc11 of the first electrode of the first compensation capacitor before entering the data writing and compensation stage and its stable voltage value Vc12 in the data writing and compensation stage is a first variation ΔVc1,
a difference between an initial voltage value Vc13 of the second electrode of the first compensation capacitor before entering the data writing and compensation stage and its stable voltage value Vc14 in the data writing and compensation stage is a second variation ΔVc2, the first variation ΔVc1 is equal to the second variation ΔVc2.

25. The driving method according to claim 22, wherein the pixel circuit further comprises an auxiliary compensation circuit, the auxiliary compensation circuit comprises a second compensation capacitor, wherein a first electrode of the second compensation capacitor is electrically connected with the second terminal of the driving circuit, and a second electrode of the second compensation capacitor is configured to receive a first constant signal, the first compensation capacitor is connected in series with the second compensation capacitor;
in the data writing and compensation stage, a voltage Vc3 of the second terminal of the driving circuit is equal to (Vdata−Vref)×[C1/(C1+C2)]+Vini1, Vdata represents a value of the data signal, Vref represents an initial voltage value of the first electrode of the first compensation capacitor before entering the data writing and compensation stage, and C1 represents a capacitance value of the first compensation capacitor, C2 represents a capacitance value of the second compensation capacitor, and Vini1 represents an initial voltage value of the second terminal of the driving circuit before entering the data writing and compensation stage.

26-27. (canceled)
